(19) United States
(12) Patent Application Publication
(10) Pub. No.: US 2026/0370316 A1
(43) Pub. Date: Nov. 19, 2026

(54) SATELLITE IMAGE ENHANCED SATELLITE-TERRESTRIAL DYNAMIC COMMUNICATION RESTRICTION ZONES

(71) Applicant: Stephen T. Palermo, Chandler, AZ (US)

(72) Inventor: Stephen T. Palermo, Chandler, AZ (US)

(21) Appl. No.: 19/720,735

(22) Filed: Jun. 25, 2026

Related U.S. Application Data
(60) Provisional application No. 63/845,296, filed on Jul. 16, 2025.

(51) Int. Cl. H04B 7/185; H04L 41/16; H04W 48/04

(52) U.S. Cl. CPC H04B 7/18519; H04B 7/1855; H04L 41/16; H04W 48/04

(57) ABSTRACT

Various approaches for using satellite images and data processing operations to assist with communication restriction zones for a satellite communication network are described. An exclusion condition is identified for satellite network transmissions based on information depicted in an image of an on-Earth geographic area. A dynamic communication restriction zone is defined to correspond to this on-Earth geographic area. At least one mitigation operation is identified for the zone based on the exclusion condition, and an activation time window is identified to enforce the zone over the geographic area. The specifications of the dynamic communication restriction zone are communicated to at least one satellite, to cause the satellite(s) to modify transmission operations while over the geographic area. The exclusion condition can be identified from automated detection of an object, and implementation of the zone can disable, attenuate, or steer transmission beams away from the on-Earth geographic area.

### PRIORITY CLAIM

This application claims the benefit of priority to U.S. Provisional Patent Application No. 63/845,296, filed Jul. 16, 2025, and titled “SATELLITE IMAGE ENHANCED SATELLITE-TERRESTRIAL EXCLUSION, INCLUSION, AND COORDINATION ZONES”, which is incorporated herein by reference in its entirety.

### BACKGROUND

Various approaches are being investigated to mitigate potential harmful interference from satellite non-terrestrial network systems onto existing terrestrial network services, including for Supplemental Coverage from Space (SCS) services. For example, the Alliance for Telecommunications Industry Solutions (ATIS) has developed various draft forms of an Exclusion Zone Definition (ezD) and an associated Exclusion Zone Protocol (ezP) that are used to establish conditions in which a satellite network modifies its operation.

A number of other standards and technical research efforts are also being developed for satellite Non-Terrestrial Networks (NTNs) as these networks are increasingly integrated with 5G and subsequent technologies. This includes efforts from satellite operators and other organizations to develop technical positions and aligned contributions that advance the support of NTNs in network deployments, including coordination with efforts and ecosystem issues that are covered (and not covered) by 3GPP standards.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIGS. 1A and 1B illustrate different aspects of defining an exclusion zone definition based on geographic characteristics, according to an example;

FIG. 2 illustrates a flowchart of a process for updating an exclusion or inclusion zone protocol based on the use of satellite imaging, according to an example;

FIG. 3 illustrates a use case for evaluating satellite imaging in connection with establishing an exclusion or inclusion zone, according to an example;

FIG. 4 illustrates a flowchart of a process for controlling satellite network operations with a dynamic communication restriction zone based on image information, according to an example;

FIG. 5 illustrates network connectivity in non-terrestrial (satellite) and terrestrial (e.g., mobile cellular network) settings, according to an example;

FIGS. 6A, 6B, and 6C illustrate scenarios of geographic satellite connectivity from low-Earth orbit satellite communication networks, according to an example;

FIGS. 7A, 7B, and 7C illustrate respective configurations of non-terrestrial and 5G network architectures, according to an example;

FIG. 8 illustrates an implementation of exclusion zones provided for transmissions from a non-terrestrial communication network, according to an example;

FIG. 9 illustrates various types of exclusion zones implemented for transmissions from a non-terrestrial communication network, according to an example;

FIG. 10 illustrates a flowchart of an example method of implementing exclusion zones for communications from a non-terrestrial communication network, according to an example;

FIGS. 11A and 11B illustrate exclusion zones implemented for transmissions from a non-terrestrial communication network, according to an example.

FIG. 12 illustrates a network architecture for implementing exclusion zones for transmissions from a non-terrestrial communication network, according to an example;

FIGS. 13A and 13B illustrate further views of exclusion zones implemented for transmissions from a non-terrestrial communication network, according to an example;

FIG. 14A illustrates an overview of example components deployed at a compute node system, according to an example;

FIG. 14B illustrates a further overview of example components within a computing device, according to an example; and

FIG. 15 illustrates a software distribution platform to distribute software instructions and derivatives, according to an example.

### DETAILED DESCRIPTION

The following discussion relates to various aspects of non-terrestrial network (NTN) constellation operations, including aspects of supplemental space coverage (SCS), which are modified for use with communication restriction zones such as exclusion, coordination, and inclusion zones. An exclusion zone, as described below, is a zone tied to a defined geographic area where a non-terrestrial network is required to disable, attenuate, or steer away its radio frequency or light transmissions to prevent interference with existing terrestrial services or protected sites. An inclusion zone, as described below, is a defined geographic area within which a non-terrestrial network increases or guarantees transmission coverage, within applicable regulatory limits, to ensure SCS service or connectivity to terrestrial subscribers.

One aspect of this disclosure introduces the use of satellite imagery to corroborate (verify) an exclusion zone (EZ) or inclusion zone (IZ), such as used for validating visual telemetry when an EZ is active. Another aspect of this disclosure introduces the use of satellite imagery together with an AI inference model to automatically generate the EZ or IZ for a dynamic or changing on-Earth location. Such implementations use high-resolution satellite or above-earth (aerial) images (e.g., captured with or from the LEO or GEO, or provided from an imaging service) and an associated AI inference model to establish, change, or remove an EZ or an IZ.

As non-limiting examples, satellite imagery is used together with one or more artificial intelligence (AI) inference models in an automated process to generate an EZ or IZ definition from user-traced or automatically-detected boundaries on the imagery. The automated process can also verify that the EZ or IZ is being enforced by the constellation during an activation time window using visual telemetry. The automated process can also monitor the geographic area covered by the EZ or IZ during the activation time window and automatically (or semi-automatically) adjust the EZ or IZ definition in response to detected changes on the ground or in the airspace covered by the EZ/IZ zone.

The use of satellite imagery to define and modify an active EZ helps satisfy a variety of technical regulations and mitigate concerns with a variety of satellite types and use cases. The use of satellite imagery to autogenerate the EZ/IZ also helps simplify the “data entry” process for determining and customizing the EZ/IZ while increasing the accuracy of the resulting changes. As discussed below, relevant data specifications (such as ATIS or 3GPP specifications) may be expanded to include the use of object detection-based AI models for EZ/IZs, including to define temporary zones for real-world changes.

Additionally, the use of near-real-time or low-latency imagery can be used to adjust power between satellite-to-earth ground station feeder links, and to maintain channel state information and/or save power onboard satellites. For example, a major unexpected environmental condition appearing in the image can be used to trigger an increase in power while maintaining the predetermined EZ radiation attenuation limits (e.g., using the images during the flyover period of exclusion zone activation that typically lasts up to 8 minutes for LEOs). Such adaptive capabilities are important for both LEO constellations and direct coverage constellations.

The following provides an overview of EZs and IZs, followed by implementation details of the use of imagery for establishing or updating EZs and IZs, and implementation details for EZs and IZs in various environments.

### Overview of Exclusion Zones

In an example, an Exclusion Zone (EZ) is defined as a fixed geographical area using center location coordinates and a radius. An EZ prevents or changes radio transmissions from the satellite in the geographical area corresponding to the geometry. An EZ implementation either (1) disables the source of transmission in-orbit to prevent transmission over the geographical area, (2) attenuates transmission below a minimum allowed threshold, or (3) steers the satellite beams away from the EZ. An EZ can also prevent radio frequency or light transmissions. An EZ can also be referred to as a prohibited area.

The Exclusion Zone Protocol (ezP) discussed below also carries information between the 5G NG-RAN (Next Generation Radio Access Network) and the AMF (Access and Mobility Management Function) (or its equivalent). The ezP is used to support the following EZ functions:
Transfer EZ (ezD) request from the AMF (or equivalent) to the NG-RAN;
Transfer the EZ response from the NG-RAN to the AMF;
Exchange information between the NG-RAN and the AMF for the purpose of scheduling an EZ;
Other information exchanges may occur between the AMF and the Satellite Operator.

The ezP protocol terminates between the AMF and the NG-RAN and is used as transport for EZ requests and EZ responses messages over the NG-C interface. The NGAP protocol is also used to initiate and terminate NG-RAN Node related procedures.

An exclusion zone may be defined with the ezP protocol based on multiple types of information elements. These may include:

TABLE 1

| ezDescription | This EZ Definition minimally includes ezName, |
|---|---|
| (ezD) | ezActivationTime, ezCenter, and ezRadius |
| ezName | The unique EZ name |
| ezActivationTime | The time period of an EZ |
| ezCenter | The geographical Center Position point of the EZ |
| ezRadius | The geographical radius from the EZ Center Position |
| | point of the EZ |
| ezOffsetCenter | Used when EZ definition type is “Referenced,” the |
| | geographical EZ Offset Center point position from |
| | the EZ Center Position |
| ezOffsetDistance | Used when EZ definition type is “Referenced,” the |
| | geographical distance from the EZ Offset center |
| | position |
| ezProtocol (ezP) | The EZ Protocol minimally includes |
| | ezActivationRequest, and ezActivationResponse |
| ezMethod (ezM) | Requested accommodation method can be either |
| | ezDisable, ezAttenuation, or ezBeamsteering |

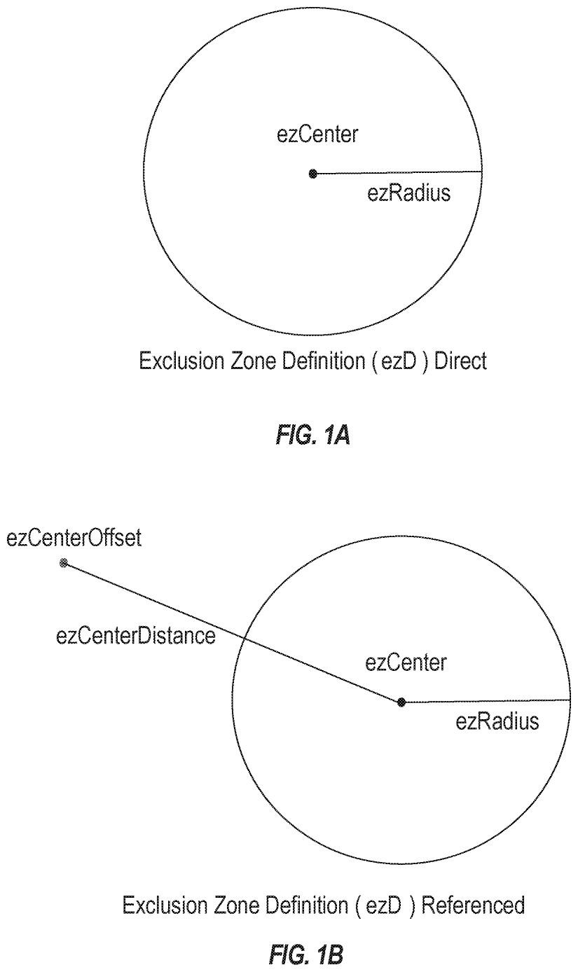

FIG. 1A depicts an example of a direct exclusion zone definition, based on an EZ established around the radius of an ezCenter. FIG. 1B depicts an example of an indirect exclusion zone definition, based on an EZ established around the radius of an ezCenter which in turn is located at an ezCenterDistance from an ezCenterOffset. This indirect exclusion zone definition may be accompanied by a vector direction from the ezCenterOffset to determine the direction or position of the ezCenter. Although round geometries are depicted in these examples, other geometrical shapes may be established and tracked.

In FIG. 1A, a center point, ezCenter, identifies the geographical center position of the exclusion zone, and a radius, ezRadius, which extends from ezCenter to the boundary of the circular area and defines the geographical radius from the center position. The geographical center position may be expressed in various ways, such as with a latitude and longitude, projected or metric grid systems, discrete global grid systems, or cartesian 3D geocentric systems. With a direct definition, ezCenter and ezRadius specify the location and extent of the exclusion zone using the center coordinate and radius values directly.

In FIG. 1B, the referenced definition type adds two further parameters. An offset point, ezCenterOffset, identifies a geographical offset center point position located adjacent to or apart from ezCenter. A distance, ezCenterDistance, represents the geographical distance between ezCenterOffset and ezCenter. In the referenced definition type, the position of ezCenter is expressed relative to ezCenterOffset by way of ezCenterDistance, allowing the exclusion zone to be located by reference to a separate offset point (and, as applicable, a vector direction from the offset point) rather than by the center coordinate alone.

### Exclusion Zone Verification and Generation via Satellite Imagery

Many manual workflows for establishing EZs involve an operator calculating geographic coordinates and radius values for individual exclusion zones (e.g., in accordance with the ezP discussed above), then manually entering the exclusion zone values into a scheduling and planning system for propagation to the constellation. This approach does not scale. A single satellite operator may be responsible for hundreds or thousands of EZs spanning regulatory zones (e.g., national landing-rights restrictions), permanent protected sites (e.g., radio astronomy observatories), commercial zones (e.g., terrestrial data-center microwave-backup links), and temporary or ephemeral zones (e.g., newly-constructed communication sites, resource-extraction sites, large public gatherings, vessels in transit, or aircraft following a flight path). As will be understood, calculating and maintaining EZs manually is time-consuming and error-prone, and re-calculation will need to occur any time the physical footprint of the protected object moves or the protected area changes size.

In addition, many workflows do not provide visual corroboration that a defined EZ is actually being enforced. Once an EZ is scheduled and propagated to an in-orbit constellation, the operator has no independent mechanism to verify that the affected beams or frequencies are in fact disabled, attenuated, or steered away during the activation time window.

The following introduces approaches for improved exclusion zone definition and verification. This exclusion zone verification may be implemented using an exclusion zone definition that is controlled (established, updated, or removed) based on satellite image analysis operations.

For example: ezSatelliteImageCapture BOOLEAN may provide a defined data value that is used to corroborate (verify) an active EZ using visual telemetry.

Implementation can be automated via the use of an AI inference model with the following data definition:
ezSatelliteImageCapture BOOLEAN

Enabled status:
ezSatelliteImageCapture ::= TRUE

Disabled status:
ezSatelliteImageCapture ::= FALSE

If enabled, Satellite Images are captured during the ExclusionZoneActivationWindow at a frequency defined by ezSatelliteImageCaptureFrequency ENUMERATED {second, minute}. This controls the cadence of satellite image capture during the ExclusionZoneActivationWindow.

In further examples, when ezSatelliteImageCapture is TRUE the exclusion zone is activated using visual telemetry, intended to be driven by an automated AI inference model or an agentic AI agent as discussed elsewhere herein.

In further examples, additional data values or flags (or metadata) may be used to designate that a particular EZ or IZ was created using AI inferencing.

Implementation can use high-resolution satellite images from a LEO or GEO network, and an associated AI inference model previously trained to generate ezP parameters. Image capture may include metadata such as geolocation and time.

The use of satellite imagery on an active EZ helps satisfy the regulations and mitigate concerns with competing solutions. As will be understood, improved accuracy may be achieved using telemetry generated by actual data (real-world photo) using AI inferencing.

In an example, exclusion zone generation may be implemented using an exclusion zone definition that controls the generation of the exclusion zones from image data. For example: ezAutoGenerationViaSatelliteImage BOOLEAN may be defined and used to automatically generate the exclusion zones.

AI Generated may be provided by status:
ezAutoGenerationViaSatelliteImage ::= TRUE

NOT AI Generated may be provided by status:
ezAutoGenerationViaSatelliteImage ::= FALSE

The use of satellite imagery to autogenerate the EZ helps simplify the “data entry” process. The ezP specification may also include parameters used by AI inference models necessary to generate the ezP instances.

In a further example, a generative-AI auto-adjustment flag (e.g., genAIezSatelliteImageCapture), when provided, enables a generative AI model to monitor inference results within the zone and automatically adjust the zone geometry. Likewise, an optional model identifier field can be used to designate the specific AI model used for this purpose (e.g., a named vision model).

These techniques can be extended for the use of an inclusion zone (IZ) based on satellite imagery, where coverage is guaranteed or prioritized. Similar to an EZ where there are attenuation limits, an IZ can be used for SCS in conditions that need to ensure coverage by increasing transmission power (e.g., to mitigate interference at a particular location).

As with an EZ, an IZ can be verified and generated from imagery. An IZ verification flag, when enabled, can be used to cause image capture during an inclusion zone activation time window to corroborate that coverage is being provided; an IZ generation flag, when enabled, can cause an AI inference model to generate the IZ definition from imagery. The IZ may use the same or varying parameters and data elements described above for the EZ.

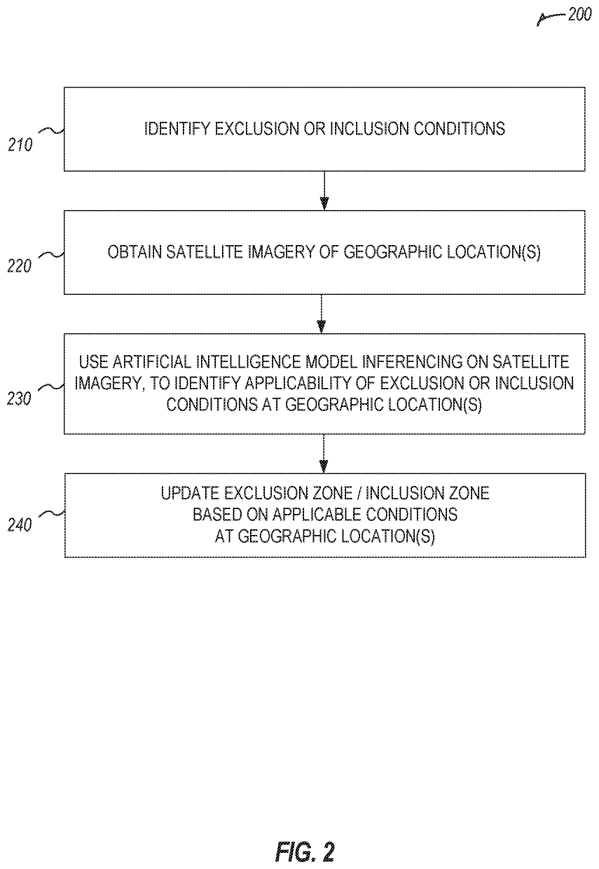

FIG. 2 depicts a flowchart 200 of an example method for generating or modifying an exclusion or inclusion zone with satellite imagery.

At operation 210, exclusion or inclusion conditions are identified, applicable to the operation of an NTN or SCS deployment. An exclusion condition corresponds to a circumstance under which transmissions from a satellite network are to be prevented, attenuated, or steered away from a geographic location, such as a condition arising from regulatory restrictions, sensitive areas, or interference avoidance with existing services, including radio astronomy. An inclusion condition corresponds to a circumstance under which transmissions are to be required, increased, or directed toward a geographic location to maintain coverage.

At operation 220, satellite imagery of one or more geographic locations covered by the NTN or SCS deployment is obtained. The imagery can be sourced from a low Earth orbit (LEO) or geostationary (GEO) satellite, and image capture can include metadata such as location and time. The imagery provides visual telemetry of the geographic location associated with the conditions identified at operation 210.

At operation 230, an artificial intelligence model (e.g., a neural network) is used to perform inferencing on the obtained satellite imagery. The AI inference model, previously trained on associations of satellite images and zone definitions, processes the imagery to detect objects or scenarios depicted in the imagery and determine whether the conditions identified at operation 210 apply at the geographic location. This operation corresponds to verification of an active zone using visual telemetry and to detection of changes on the ground that affect the applicability of a zone.

At operation 240, the exclusion zone or the inclusion zone is generated or updated, based on the identified applicable exclusion or inclusion conditions at the one or more geographic locations. The update can include defining a new zone, adjusting the geometry of an existing zone in response to detected changes (such as expansion of an area when additional objects are detected), or changing the status of a zone. The update can be performed by an AI process automatically or in response to operator input.

The method of flowchart 200 can repeat to provide ongoing monitoring of the geographic locations, with operations 220, 230, and 240 carried out during an activation time window of the zone at a regular capture cadence defined for the zone.

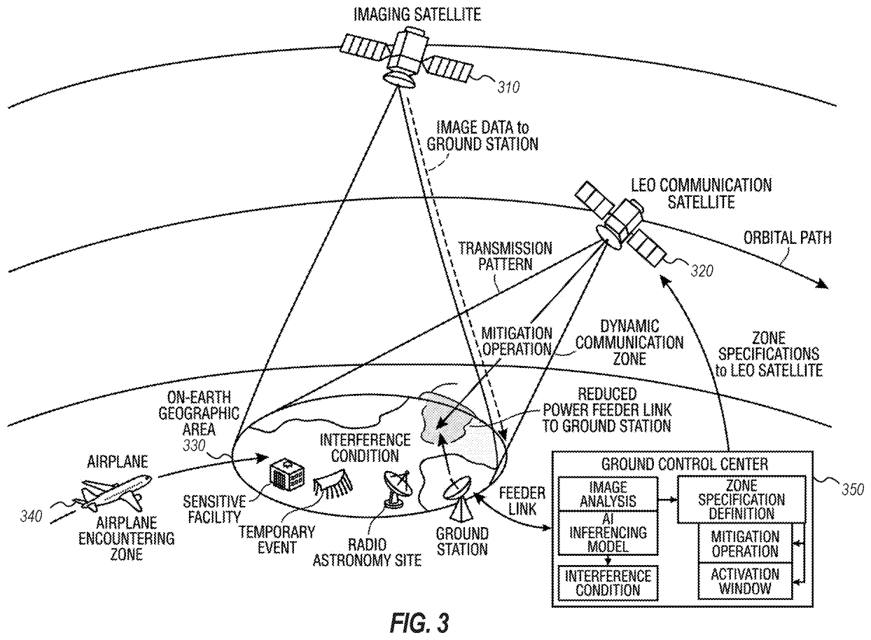

FIG. 3 depicts an example use case for evaluating and using satellite imaging in connection with establishing a communication restriction zone. In this scenario, an imaging satellite 310 captures at least one image of an on-Earth geographic area 330 and transmits the resulting image data to a ground station. The imaging satellite 310 provides the source imagery from which an exclusion condition is identified, consistent with the use of high-resolution satellite imagery. This satellite imagery may be provided from a dedicated or a multi-function LEO or GEO satellite, but in other examples, imagery may be provided by other aerial sources (e.g., planes, balloons, drones, etc.). In some examples, the imaging satellite 310 and the LEO communication satellite 320 belong to the same satellite or the same satellite constellation, such that the satellite that captures the imagery also provides the transmission operations.

A LEO communication satellite 320 travels along an orbital path and provides transmission operations toward the on-Earth geographic area 330. The LEO communication satellite 320 receives zone specifications and modifies its transmission pattern while over the on-Earth geographic area 330, applying a mitigation operation that establishes the dynamic communication zone. In some examples, the mitigation operation can include a reduction of power on a feeder link to a ground station located within the on-Earth geographic area 330.

The on-Earth geographic area 330 contains one or more features that give rise to an interference condition. The depicted features may include one or more of: a sensitive facility, a temporary event, or a radio astronomy site.

An airplane 340 is depicted entering the on-Earth geographic area 330. The airplane 340 represents a moving object that can be detected from the imagery, which can prompt adjustment of the dynamic communication zone. Other types of moving objects may include vehicles, ships, or other artifacts entering or moving within a monitored zone.

A ground control center 350 performs processing associated with the dynamic communication zone. The ground control center 350 includes an image analysis AI inferencing model that receives the image data, and determines an interference condition output identified by the AI inferencing model, a zone specification definition, a mitigation operation, and an activation time window. In one example, the AI inferencing model of the ground control center 350 directly processes the captured imagery as input to a trained model to identify the interference condition and to generate the geographic parameters, the mitigation operation, and the activation time window that form the zone specifications.

The ground control center 350 communicates the zone specifications to the LEO communication satellite 320 to cause the satellite to modify its transmission operations while over the on-Earth geographic area 330. In some examples, the processing functions of the ground control center 350 are performed by a computing device located on-Earth; in other examples, similar processing is performed in a satellite vehicle.

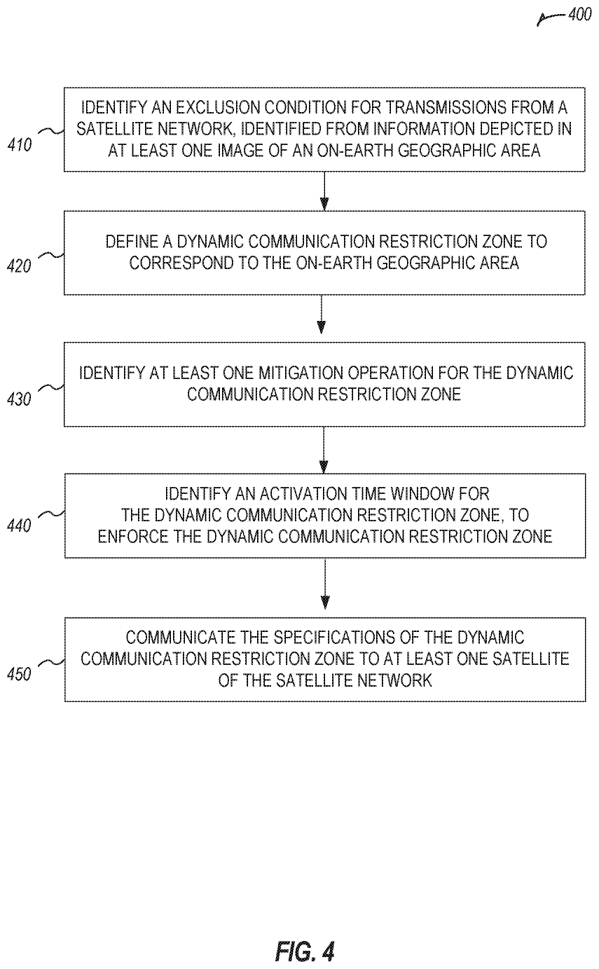

FIG. 4 depicts a flowchart 400 of an example method for controlling satellite network operations by defining and enforcing a dynamic communication restriction zone. In various examples, this method may be performed by a computing device located on-Earth (e.g., at a ground station) or located in a satellite vehicle (e.g., at a centralized satellite compute station). Additionally, the communication of specifications of the following dynamic communication restriction zone may be provided from the computing device to a satellite network in connection with telemetry tracking and command (TTC) information for the satellite network.

At operation 410, an exclusion condition for transmissions from a satellite network is identified from information depicted in at least one image of an on-Earth geographic area. The identification of the exclusion condition can be based on an automated detection of an object or a scenario associated with the object, from the information depicted in the at least one image. The at least one image of the on-Earth geographic area can be captured by a satellite image source or an aerial image source, and in some examples is captured by a same satellite or a same satellite constellation that provides the transmission operations.

The automated detection of the object or the scenario associated with the object can be performed using at least one artificial intelligence (AI) inference model, such as various types of trained or conditioned neural networks. In some examples, the satellite network being evaluated is a LEO satellite communications network comprising a plurality of satellites in at least one constellation. In further examples, the automated detection may be invoked or directed by at least one AI agent and the use of agentic data processing workflows that invoke or control the automated detection using the at least one AI inference model or related AI data processing. For instance, an AI agent specifically directed to autonomously generate EZs can trigger and use satellite imagery monitors to determine if there is a need for a change to an existing EZ, and then automatically effectuate the change (where and when needed) based on the results of an AI inference process.

At operation 420, a dynamic communication restriction zone is defined to correspond to the on-Earth geographic area. The on-Earth geographic area can be a fixed geographic area, and the dynamic communication restriction zone can correspond to an area shape defined relative to a fixed point within (or an offset fixed point located adjacent to) the on-Earth geographic area. The area shape can be a circle, a rectangle, a polygon, or a multi-point shape derived from at least one object depicted in the at least one image of the on-Earth geographic area. In specific examples, this area shape is a polygon-like shape derived from a satellite image and bounded by user-placed points (with a free-form or random point count) as drawn or confirmed via a graphical user interface. In still other examples, an AI inference model, AI agent, or another AI-driven process may determine a polygon-like shape derived from a satellite image using automatically detected points.

Defining the dynamic communication restriction zone can be based on an automated definition of the dynamic communication restriction zone performed using at least one AI inferencing model. For instance, this at least one inferencing model may be used in an automated process that receives the at least one image of the on-Earth geographic area as input and provides (i) geographic parameters of the on-Earth geographic area, (ii) the at least one mitigation operation, and (iii) the activation time window as outputs. In a further example, this automated process may be initiated, controlled, or directed by at least one AI agent (and Agentic AI workflows) that invokes the at least one AI inferencing model (e.g., as the at least one AI agent coordinates the data processing and provides outputs autonomously or in response to a user request).

In some examples, the dynamic communication restriction zone is an exclusion zone configured to (i) disable transmissions from the satellite network to the on-Earth geographic area, (ii) attenuate a transmission from the satellite network to the on-Earth geographic area, or (iii) steer one or more transmission beams of the satellite network away from the on-Earth geographic area. In other examples, the dynamic communication restriction zone is an inclusion zone configured to (i) require transmissions from the satellite network to the on-Earth geographic area, (ii) increase transmissions from the satellite network to the on-Earth geographic area, or (iii) direct one or more transmission beams of the satellite network to the on-Earth geographic area.

At operation 430, at least one mitigation operation for the dynamic communication restriction zone is identified, based on the exclusion condition. The at least one mitigation operation can be a communication exclusion or coordination restriction to mitigate transmissions (or an inclusion requirement to increase transmissions) from the satellite network to the on-Earth geographic area, based on use of at least one mitigation provided from spot beam control, frequency change, or beam steering.

In some examples, the communication exclusion or coordination restriction controls satellite communications to terrestrial terminals established with a direct attachment to a user equipment, in accordance with one or more frequency bands defined by a Fifth Generation (5G) Non-Terrestrial Network (NTN) network specification. In some examples, implementation of the dynamic communication restriction zone with the at least one satellite causes a power adaptation to a feeder link between the satellite network and a ground station, such as for a ground station located within the on-Earth geographic area or within a predefined radius of the on-Earth geographic area.

At operation 440, an activation time window for the dynamic communication restriction zone is identified, which is used to enforce the dynamic communication restriction zone over the on-Earth geographic area. The activation time window defines the period during which the at least one satellite applies the mitigation operation as the satellite passes over the on-Earth geographic area.

At operation 450, the specifications of the dynamic communication restriction zone are communicated to at least one satellite of the satellite network, to cause the at least one satellite of the satellite network to modify transmission operations while over the on-Earth geographic area. The specifications communicated at operation 450 may include the parameters defined at operations 420, 430, and 440, including: the geographic parameters of the dynamic communication restriction zone, the at least one mitigation operation, and the activation time window.

In some examples, once an EZ is active, the same or a different AI inference model is applied to imagery captured during the activation time window to detect objects within the bounded zone. If a detected object enters, leaves, or changes position or size relative to the existing EZ geometry, the system either (a) issues an alert to an operator with an option to manually edit the configuration mask, or (b) in an auto-adjust mode, causes the AI inference model to regenerate the configuration mask and emit an updated ezD instance for propagation to the constellation.

In various examples, a graphical user interface (GUI) can be used in connection with the previously discussed techniques. For example, consider a scenario where a GUI presents satellite imagery of a candidate geographic area to an operator. The operator traces a closed boundary on the imagery by placing a free-form number of vertices (e.g., “configuration mask”) encompassing the object or area to be protected. A translation process converts the pixel-space configuration mask to geo-referenced coordinates (e.g., WGS-84) and outputs an ezD instance conforming to an ASN.1 exclusion zone protocol schema. In a related example, an AI inference model performs object detection on the imagery and generates the configuration mask automatically, without operator involvement.

Other aspects of active-zone monitoring and auto-adjustment may also be provided. For instance, during an activation time window of an EZ or IZ, the imagery of the zone area may be captured at a predetermined cadence and processed by an object-detection inference model. When the model detects that an object satisfying the monitored class (i) enters the zone, (ii) exits the zone, (iii) translates to a position that is no longer covered by the existing ezD geometry, or (iv) changes in size or number such that the existing ezD no longer encompasses the monitored set, a change event can be generated.

As non-limiting examples, a change event can be handled with various types of autonomous or manual outcomes. In an alert mode, an alert is issued to an operator dashboard referencing the affected ezD by identifier. The operator may accept the AI-proposed updated geometry, reject it, or manually edit the configuration mask by adding, removing, or repositioning vertices, and/or save the updated ezD instance (to be submitted through ezP). In an autonomous mode, a generative AI model generates a replacement ezD instance autonomously and the replacement is submitted through ezP without operator involvement. In a hybrid mode, auto-adjustment is permitted within configured bounds (for example, a maximum delta in polygon area, vertex count, or centroid displacement) and is escalated to an operator alert when the bounds are exceeded. These and other bounds and thresholds may be defined, per EZ, based on a permissible magnitude of automatic change (for example, based on bounding-box size delta, number of detected objects, or inter-frame motion). Only changes exceeding those thresholds trigger a regeneration in the EZ.

The foregoing workflows may be applied to a variety of fixed and moving protected objects and to permanent and ephemeral zones. Example applications include: (i) temporary resource-extraction sites that do not appear on pre-existing maps; (ii) temporary communication sites such as tactical deployments in remote areas; (iii) large public gatherings where a cellular site is erected and the population density changes day over day, causing the effective protected area to grow or shrink; (iv) commercial data centers for which satellite emissions might interfere with backup microwave or satellite links; (v) national or sub-national landing-rights enforcement in which a constellation operator without authorization to radiate over a given territory must exclude that territory; (vi) moving protected objects such as vessels in transit, aircraft on a flight route, or vehicles in convoy, where the zone must follow the object between successive imagery captures; and (vii) mission-specific deployments in which a specially-trained detection model (for example, a ship-detection model or a vehicle-detection model) is loaded into the auto-adjustment pipeline.

### Use of ASN Message and Definitions

An ASN.1 definition may be used to define the structure and content of ezD/ezP messages. Thus, EZ messages can contain any information elements (IEs) specified in the object set definitions for that message without the order or number of occurrences being restricted by ASN.1. However, a sending entity can construct an ezP message according to a Protocol Data Unit (PDU) definition.

As a non-limiting example, a definition may be provided by the ATIS Non-Terrestrial (NTN) Working Group, such as within its “Exclusion Zone (ez) Protocol (ezP)” information elements used to define Exclusion Zones and Activation Time Windows for such Exclusion Zones (e.g., April 2026 (v2) revision, as provided by the ATIS Non-Terrestrial (NTN) Working Group, which is incorporated by reference herein in its entirety).

### Example Exclusion Zone Protocol Operations and Definitions

To perform an Exclusion Zone Protocol (ezP) in accordance with an ATIS standard, the AMF (or equivalent) receives a request to accommodate an ezActivationRequest with a particular ezD;
SAT OPERATOR>EZ ACTIVATION REQUEST>AMF
   EZ ACTIVATION REQUEST (ezP IEs: ezD)

The AMF (or equivalent) determines the relevant targeted NG-RAN Node(s) then sends the ezActivationRequest to the relevant targeted ezRanNode(s).
AMF>EZ ACTIVATION REQUEST>NG-RAN(s)
   EZ ACTIVATION REQUEST (ezP IEs: ezRanNode, ezD)

The NG-RAN processes the ezActivationRequest which may include obtaining and/or transferring assistance data, including satellite orbital telemetry to determine which individual satellite(s) ezSATID, ezSATName, with location and status ezSATLocation, ezSATStatus will intercept the EZ request during the ezActivationTime. The ezMethod is also included to specify the approach used to accommodate the EZ:
NG-RAN>EZ INFORMATION REQUEST>SAT OPERATOR
   EZ INFORMATION REQUEST (ezP IEs: ezSATID, ezSATName, ezSATLocation, ezSATStatus, ezMethod)

The NG-RAN determines what individual satellite(s) will intercept ezInterceptSATID(s) the ezActivationRequest and prepares associated scheduling window ezSchedulingWindow to support satellite instructions to accommodate the EZ request. Then the NG-RAN returns the results of the EZ request, including the EZ Scheduling window(s) to the AMF for processing.
NG-RAN>EZ INFORMATION RESPONSE>AMF
   EZ INFORMATION RESPONSE (ezP IEs: ezInterceptSATID, ezSchedulingWindow)

The AMF provides the EZ Request instructions to the satellite operator including the EZ window used by the satellite operator to enable/disable radio frequency and/or light pollution to satisfy the EZ request.

The satellite operator schedules the appropriate commands within the EZ scheduling window, and then informs the AMF the ezActivationResponse ezSuccess/ezFailure
SAT OPERATOR<AMF<EZ ACTIVATION RESPONSE
   EZ ACTIVATION RESPONSE (IEs: ezP: ezActivationResponse ezSuccess/ezFailure)

Exclusion Zone Definition (ezD)—Information Element. This information element contains the geographical coordinates for the EZ Definition (ezD). An ezD can be defined as a circular or rectangular area. Example information elements may be used for an exclusion zone in accordance with an ATIS specification as follows.

TABLE 2

| IE / Group | Pres- | IE Type and | |
|---|---|---|---|
| Name | ence | Reference | Semantics Description |
| CHOICE EZ | | | |
| Definition | | | |
| Type | | | |
| >Direct | | | |
| >>EZ Center | M | EZ Center | The geographical Center |
| | | Position | Position point of the EZ. |
| >>EZ Radius | M | EZ Radius from | The geographical radius |
| | | Center | from EZ Center Position |
| | | | point of the EZ. |
| >Referenced | | | |
| >>EZ Center | O | EZ Offset Center | The geographical EZ |
| Offset | | Position | Offset Center point |
| | | | position from the EZ |
| | | | Center Position. |
| >>EZ Offset | O | EZ Offset | The geographical distance |
| Distance | | Distance from | from the EZ Offset center |
| | | | position. |
| CHOICE EZ | M | | |
| Coordinate | | | |
| Type | | | |
| >Geodetic | | | |
| >>EZ | M | Geodetic Location | Use geodetic coordinates |
| Geodetic | | of EZ IEs. | for the EZ IEs. |
| >Cartesian | | | |
| >>EZ | M | Cartesian | Use cartesian coordinates |
| Cartesian | | Location of EZ | for the EZ. |
| | | IEs. | |

### Overview of Non-Terrestrial Network Configurations

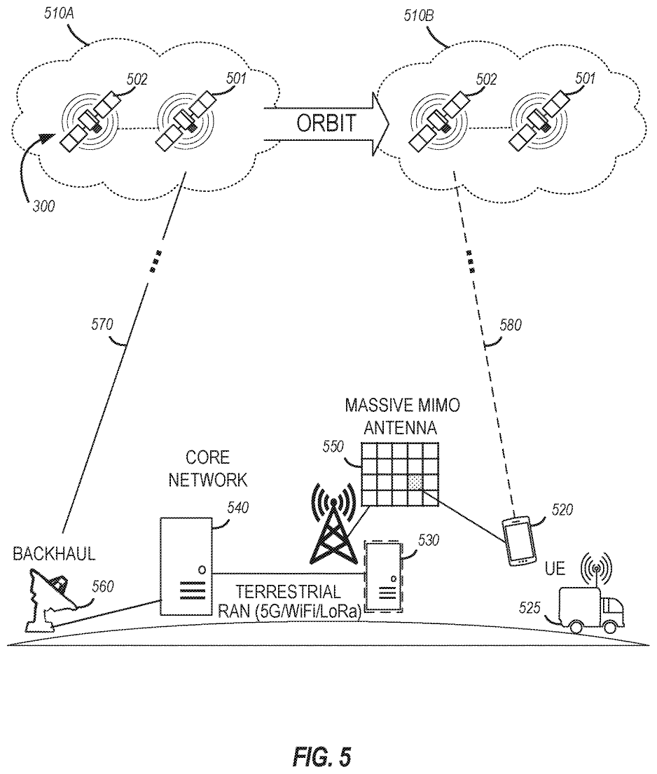

FIG. 5 illustrates network connectivity in non-terrestrial (satellite) and terrestrial (e.g., mobile cellular network) settings, according to an example. As shown, a satellite constellation 500 (the constellation depicted in FIG. 5 at orbital positions 510A and 510B) may include multiple satellite vehicles (SVs) 501, 502, which are connected to one or more other SVs and to one or more terrestrial networks. The individual satellites in the constellation 500 (e.g., SVs) conduct an orbit around the Earth, at an orbit speed that increases as the SV is closer to Earth. LEO constellations are generally considered to include SVs that orbit at an altitude between 160 and 1000 km; at this altitude, an SV typically orbits the Earth about every 90 to 120 minutes.

The constellation 500 includes individual SVs 501, 502 (and numerous other SVs not shown), and uses multiple SVs to provide communications coverage to a geographic area on Earth. The constellation 500 may also coordinate with other satellite constellations (not shown), and with terrestrial-based networks, to selectively provide connectivity and services for individual devices (user equipment) or terrestrial network systems (network equipment).

In this example, the satellite constellation 500 is connected via a satellite link 570 to a backhaul network 560, which is in turn connected to a 5G core network 540. The 5G core network 540 is used to support 5G communication operations with the satellite network and at a terrestrial 5G radio access network (RAN) 530. For instance, the 5G core network 540 may be located in a remote location and use the satellite constellation 500 as the exclusive mechanism to reach wide area networks and the Internet. In other scenarios, the 5G core network 540 may use the satellite constellation 500 as a redundant link to access the wide area networks and the Internet; in still other scenarios, the 5G core network 540 may use the satellite constellation 500 as an alternate path to access the wide area networks and the Internet (e.g., to communicate with networks on other continents).

FIG. 5 additionally depicts the use of the terrestrial 5G RAN 530 to provide radio connectivity to a user equipment (UE), such as user device UE 520 or vehicle UE 525 located on-ground, via a massive MIMO antenna 550. It will be understood that a variety of 5G and other network communication components and units are not depicted in FIG. 5 for purposes of simplicity. In some examples, the UE 520 or 525 may also have its own satellite connectivity hardware (e.g., receiver circuitry and antenna) to directly connect with the satellite constellation 500 via satellite link 580. Although a 5G network setting is depicted and discussed at length in the following sections, it will be apparent that other variations of 5GPP, O-RAN, and other network specifications may also be applicable.

Other permutations (not shown) may involve a direct connection of the 5G RAN 530 to the satellite constellation 500 (e.g., with the 5G core network 540 accessible over a satellite link); coordination with other wired (e.g., fiber), laser or optical, and wireless links and backhaul; multi-access radios among the UE, the RAN, and other UEs; and other permutations of terrestrial and non-terrestrial connectivity. Satellite network connections may be coordinated with 5G network equipment and user equipment based on satellite orbit coverage, available network services and equipment, cost and security, and geographic or geopolitical considerations, and the like. With these basic entities in mind, and with the changing compositions of mobile users and in-orbit satellites, the following techniques describe ways in which terrestrial and satellite networks can be extended for various edge computing scenarios.

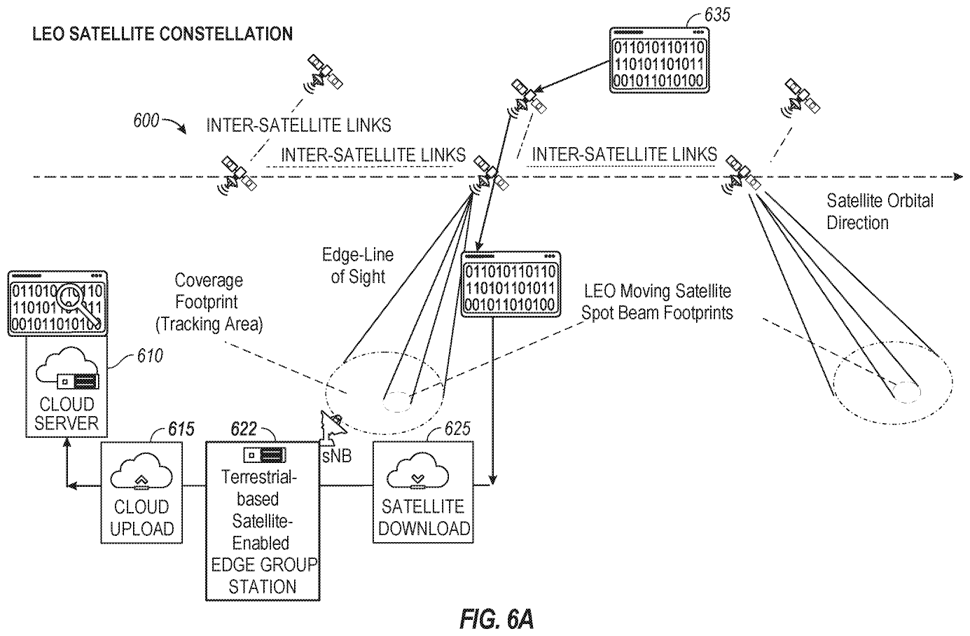

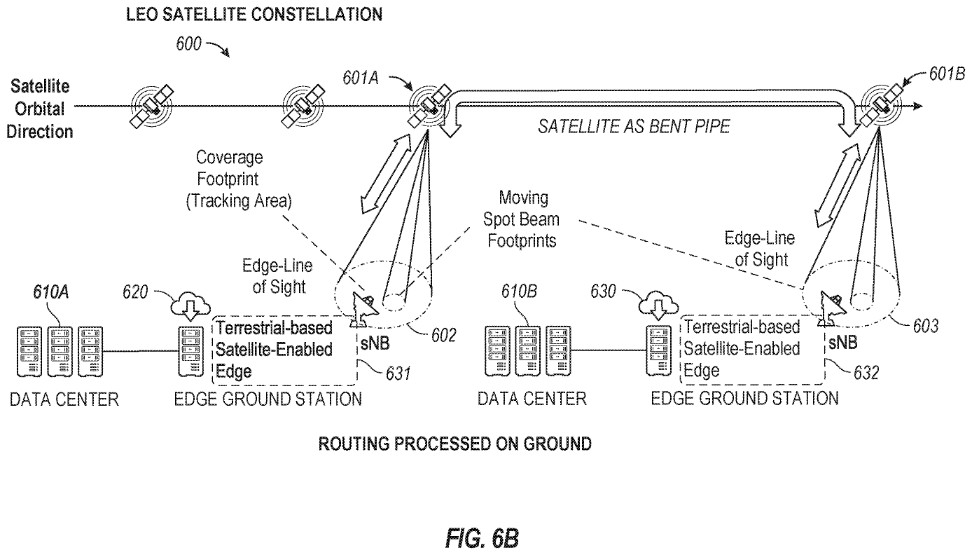

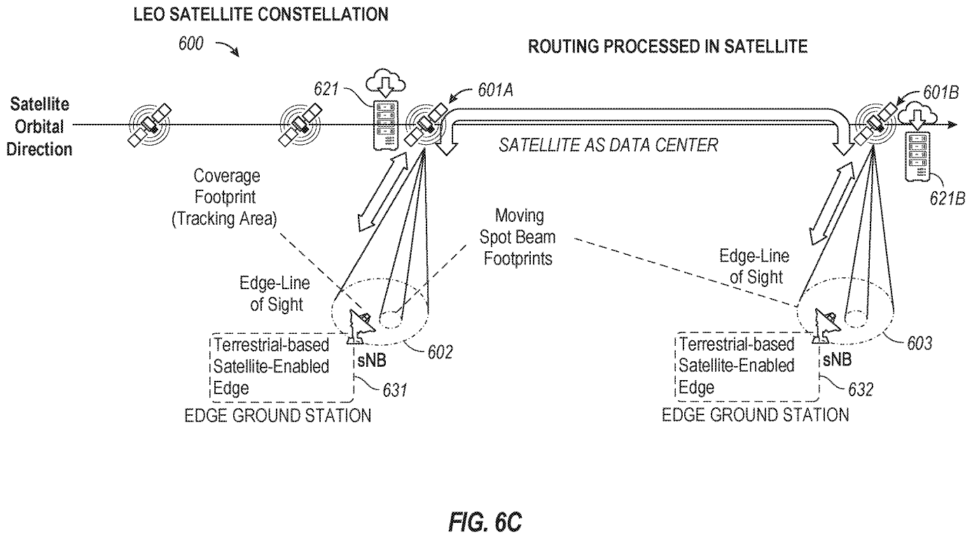

FIG. 6A illustrates an overview of terrestrial-based, satellite-enabled edge processing. As shown, a terrestrial-based, satellite-enabled edge ground station (satellite nodeB, sNB) 622 obtains coverage from a satellite constellation 600, and downloads a data set 635. The satellite constellation 600 may coordinate operations to handoff the download using inter-satellite links (such as in a scenario where the data set is streamed, or cannot be fully downloaded before the satellite footprint moves).

The satellite download 625 is provided to the sNB 620 for processing, such as with a cloud upload 615 to a server 610 (e.g., a CDN located at or near the sNB 620). Accordingly, once downloaded to the sNB 620 (and uploaded to the server 610), the user devices located within the terrestrial coverage area (e.g., 5G coverage area) of the sNB 620 may now access the data from the server 610.

FIG. 6B illustrates a terrestrial-based, satellite-enabled edge processing arrangement, where routing is performed “on-ground” and the satellite is used as a “bent pipe” between edge processing locations. Here, the term “bent pipe” refers to the use of a satellite or satellite constellation as a connection relay, to simply communicate data from one terrestrial location to another terrestrial location. As shown in this figure, a satellite constellation 600 has an orbital path, with a respective satellite moving from position 601A to 601B, providing separate coverage areas 602 and 603 for connectivity at respective times.

Here, when a satellite-enabled edge computing node sNB 631 is in the coverage area 602, it obtains connectivity via the satellite constellation 600 (a satellite at position 601A), to communicate with a wider area network. Additionally, this edge computing node sNB 631 may be located at an edge ground station which is also in further communication with a data center 610A, for performing computing operations at a terrestrial location.

Likewise, when a satellite-enabled edge computing node sNB 632 is in the coverage area 603, it obtains connectivity via the satellite constellation 600 (a satellite at position 601B), to communicate with a wider area network. Again, computing operations (e.g., services, applications, etc.) are processed at a terrestrial location such as edge ground station 630 and data center 610B.

FIG. 6C illustrates another terrestrial-based, satellite-enabled edge processing arrangement. Similar to the arrangement depicted in FIG. 6B, this shows the satellite constellation 600 in a constellation along an orbital path, with a respective satellite moving from position 601A to 601B, providing separate coverage areas 602 and 603 at respective times. However, in this example, the satellite is used as a data center, to perform edge computing operations (e.g., serve data, compute data, relay data, etc.).

Specifically, at the satellite vehicle, edge computing hardware 621 is located to process computing or data requests received from the sNBs 631, 632 in the coverage areas 602, 603. This may have the benefit of removing the communication latency involved with another location at the wide area network. However, due to processing and storage constraints, the amount of computation power may be limited at the satellite constellation 600 and thus some requests or operations may be moved to the ground station sNBs 631, 632.

As will be understood, edge computing and edge network connectivity may include various aspects of radio access network (RAN) and software-defined networking processing. Specifically, in many of these scenarios, wireless termination may be moved between ground and satellite, depending on available processing resources. Further, in these scenarios, URLLC (ultra-reliable low latency connections) processing may be enabled, based on the configuration of inter-satellite communication links.

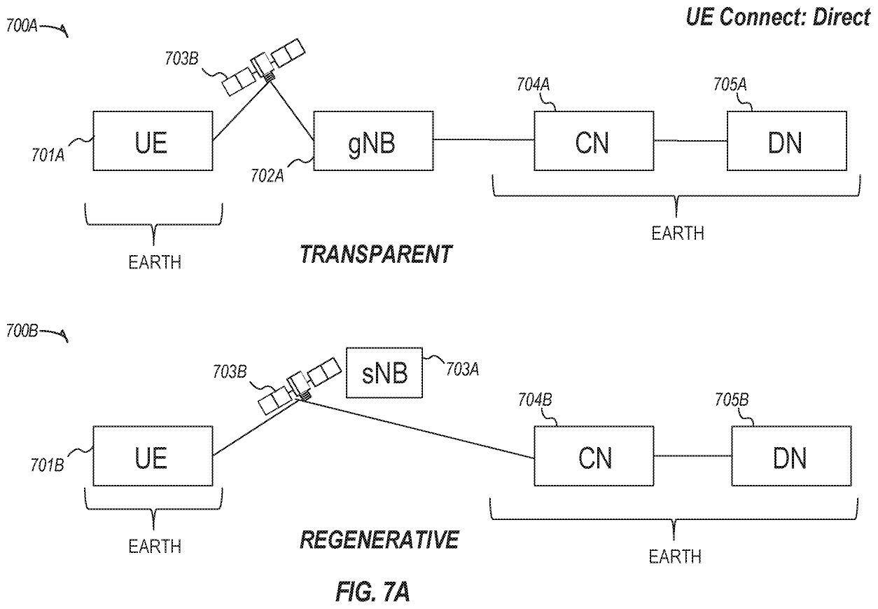

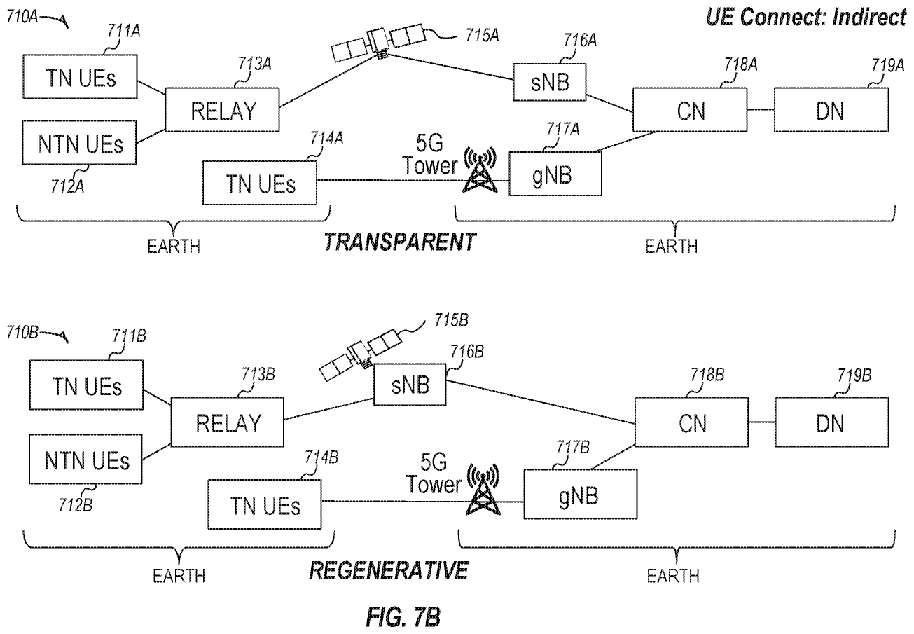

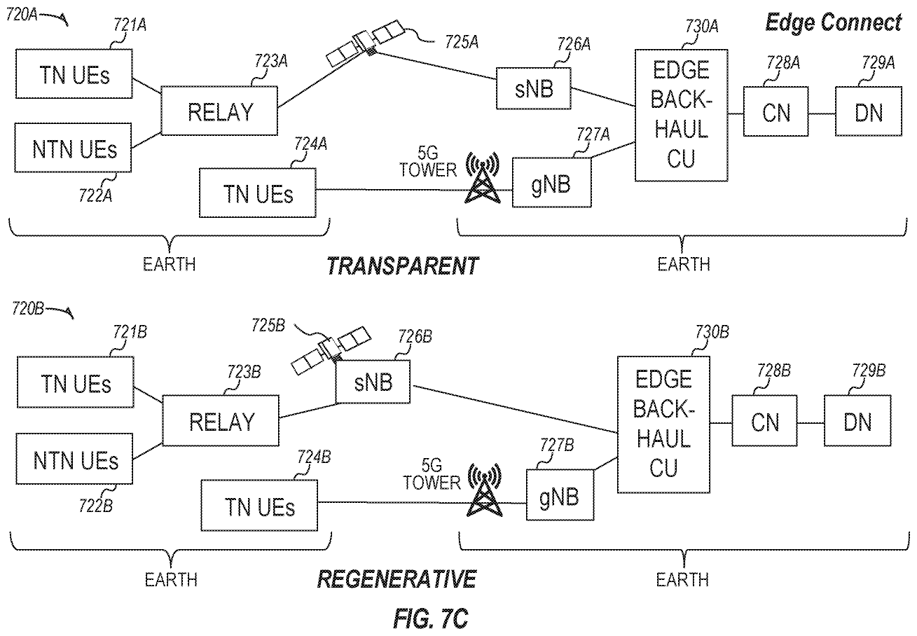

FIGS. 7A, 7B, and 7C illustrate respective configurations of non-terrestrial and 5G network architectures, which may be used with the configurations and mitigation techniques discussed herein. These include:

Direct Connection (with a transparent or “bent pipe” satellite arrangement):
Scenario 700A in FIG. 7A, e.g., Direct connect: UE 701A⇔[SATELLITE]703B⇔gNB 702A⇔CN 704A⇔DN 705A;
Scenario 710A in FIG. 7B, e.g., Multi-RAT, Multi Connectivity provided by transparent NTN-based NG-RAN and Cellular NG-RAN: UEs 711A or 712A⇔Relay 713A⇔[SATELLITE]715A⇔gNB 716A⇔CN 718A⇔DN 719A (in this scenario 710A, TN UEs 714A can directly connect to a gNB 717A and the CN 718A, DN 719A).
Scenario 720A in FIG. 7C, e.g., Multi-RAT, Multi Connectivity provided by transparent NTN-based NG-RAN and Cellular NG-RAN: UEs 721A or 722A⇔Relay 723A⇔[SATELLITE]725A⇔sNB 726A⇔Edge back-haul centralized unit (CU) 730A⇔CN 728A⇔DN 729A (in this scenario 720A, TN UEs 724A can directly connect to a gNB 727A and the CN 728A, DN 729A via the Edge back-haul CU 730A).

Direct Connection (with a regenerative satellite with gNB arrangement):
Scenario 700B in FIG. 7A: UE 701B⇔sNB 703A [at SATELLITE 703B]⇔CN 704B⇔DN 705B;
Scenario 710B in FIG. 7B, e.g., Multi-RAT, Multi Connectivity provided by transparent NTN-based NG-RAN and Cellular NG-RAN: UEs 711B or 712B⇔Relay 713B⇔sNB 716B [at SATELLITE 715B]⇔CN 718B⇔DN 719B (in this scenario 710B, TN UEs 714B can directly connect to a gNB 717B and the CN 718B, DN 719B).
Scenario 720B in FIG. 7C, e.g., Multi-RAT, Multi Connectivity provided by transparent NTN-based NG-RAN and Cellular NG-RAN: UEs 721B or 722B⇔Relay 723B⇔sNB 726B [at SATELLITE 725B]⇔Edge back-haul CU 730B⇔CN 728B⇔DN 729B (in this scenario 720B, TN UEs 724B can directly connect to a gNB 727B and the CN 728B, DN 729B via the Edge back-haul CU 730B).

### Further Examples of Exclusion Zones and Exclusion Zone Implementations

An EZ can be defined based on a fixed geographical area using center location coordinates and a radius (or other geometric area/shape around the center location). An EZ can be used to prevent or control transmission of some particular type of radio frequency in the geographical area. As examples, an EZ implementation for coordination with an NTN can be defined to (1) disable the source of transmission in-orbit to prevent transmission over the geographical area, (2) attenuate transmission below a minimum allowed threshold, or (3) steer the satellite beams away from the defined exclusion zone area. An EZ can also be referred to as a prohibited area.

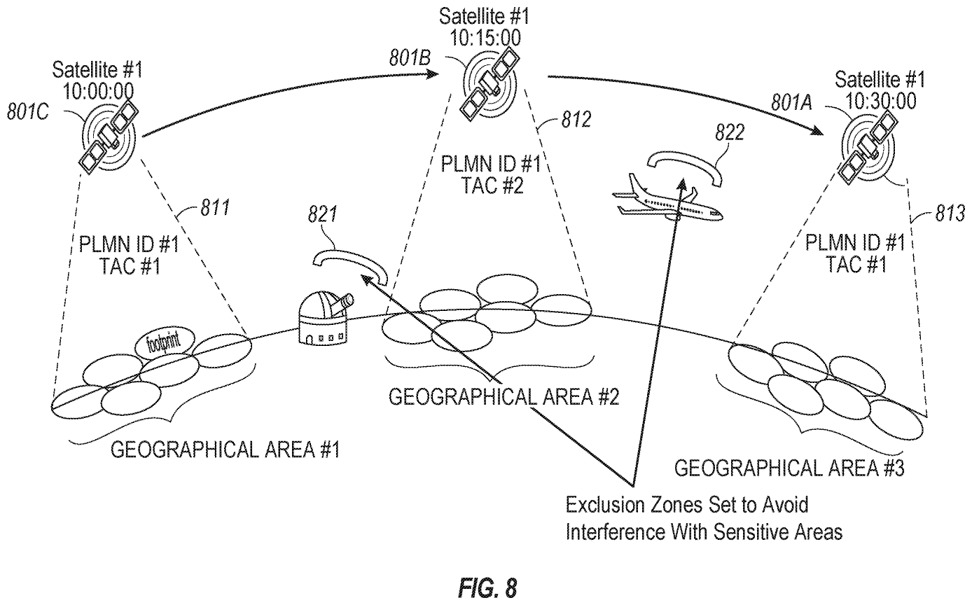

FIG. 8 illustrates an implementation of SV-based exclusion zones for a non-terrestrial communication network, according to an example. This drawing provides additional detail on an example deployment of exclusion zones, over time, relative to a satellite 801 at orbit positions 801A, 801B, 801C. At position 801A, the satellite 801 provides coverage of its spot beam(s) in a first geographic area 811; at position 801B, the satellite 801 provides coverage of its spot beam(s) in a second geographic area 812; at position 801C, the satellite 801 provides coverage of its spot beam(s) in a third geographic area 813.

FIG. 8 specifically shows the implementation of a first exclusion zone 821, which is a fixed geographic exclusion area. A fixed geographic exclusion area may be appropriate for preventing overlap with terrestrial networks that would conflict (e.g., cells established from a 4G/5G mobile network), or a fixed area(s) that is designated or instructed to be avoided (e.g., other countries, radio silence areas, sensitive monitoring equipment such as radio telescopes). FIG. 8 further shows the implementation of a second exclusion zone 822, which is a mobile geographic exclusion area. A mobile geographic area may be appropriate for objects or areas that are in motion, moveable, or whose position is not necessarily fixed in a specific geographic area (e.g., airplanes, drones, other satellites), or for an area that has an irregular or changing shape. The implementation of either type of exclusion zone prevents the satellite from beaming on the area of conflict or restriction.

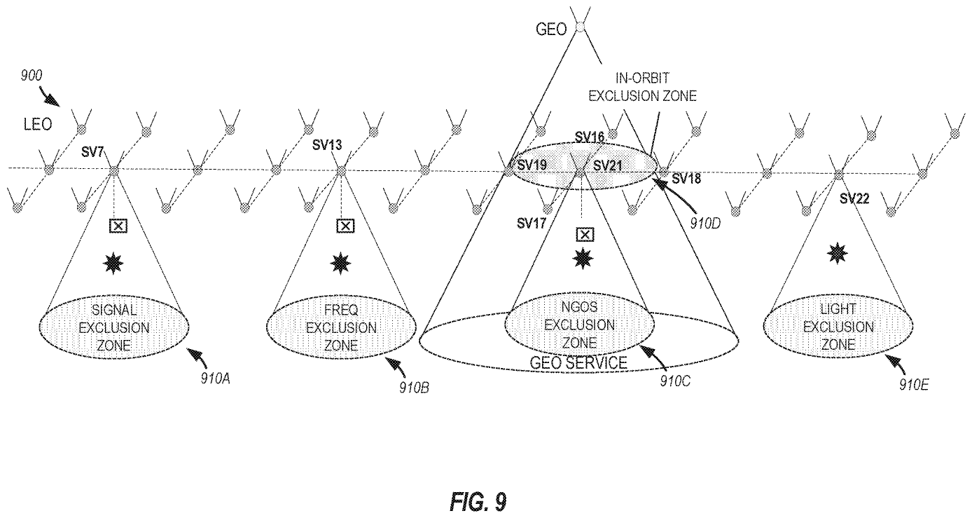

FIG. 9 illustrates further scenarios of network connectivity from an expanded view of a satellite constellation 900, with the constellation comprising dozens of LEO satellites that provide connectivity to ground UEs (not shown). Within this scenario, a number of different exclusion zones are shown for deployment: a signal exclusion zone 910A that blocks all signals from reaching a geographic area; a frequency exclusion zone 910B that blocks certain frequency signals from reaching a geographic area; a non-geostationary orbit satellite (NGOS) exclusion zone 910C that restricts signals from reaching a certain area which overlaps geostationary satellite service; an in-orbit exclusion zone 910D which restricts inter-satellite communications that occur in an overlap of geostationary satellite service; and a light pollution exclusion zone 910E which restricts reflection or causes some light reflection mitigation effect relative to a geographic area. Such exclusion zones 910A-E may be separately or concurrently deployed with one another.

In the context of FIGS. 8 and 9, exclusion zones and associated feeder links (and link scheduling) can apply to multiple constellations serviced by separate providers. For instance, different constellations may have separate GMSS identifiers (e.g., satellite equivalent of PLMN). Exclusion zones may intercept all applicable constellations, since EZs are typically “fixed” and are independent of the constellation ownership and/or providers.

Pre-determined LEO routing is often used to maintain orbit and ISL connectivity alignment and may be communicated to the LEO vehicles on a frequent (e.g., daily) basis. Exclusion zones among SVs and ISLs may be implemented to be coordinated with planned network routing calculations and communications that already occur among ground and space nodes of the LEO network. For instance, the regular communication of routing information that is provided to LEO vehicles may also be used to provide a specification of multiple EZs at the same time (including exclusion zones defined between SV-to-SV (to enable or disable ISLs) or between SV-Earth (to enable or disable geographic coverage)). The definition of exclusion zones with routing information increases efficiency of the constellations, especially for form-flying LEO constellations (e.g., similar to Iridium®, Starlink®, and the like).

In an example, exclusion zones can be calculated and provided with orbit and ISL connectivity alignment information. Thus, LEO SVs can be instructed to implement exclusion zones when receiving instructions to adjust orbital position. Such instructions may include turning various ISL connections on and off, adjusting right, left, fore, and aft antennas (regardless of implementation type), if a scenario is projected where an ISL is interfering with a higher-orbit satellite communication (or vice versa). Other considerations established with these exclusion zones may include routing that considers ground and space nodes, including EZs implemented at the same time (whether SV-to-SV or SV-earth exclusion zones), while increasing the efficiency of a constellation. These EZs may also consider that form-flying ISLs antennas may require (1) beam steering, (2) high directivity, and (3) longer ranges and larger apertures than free-flying swarm constellations.

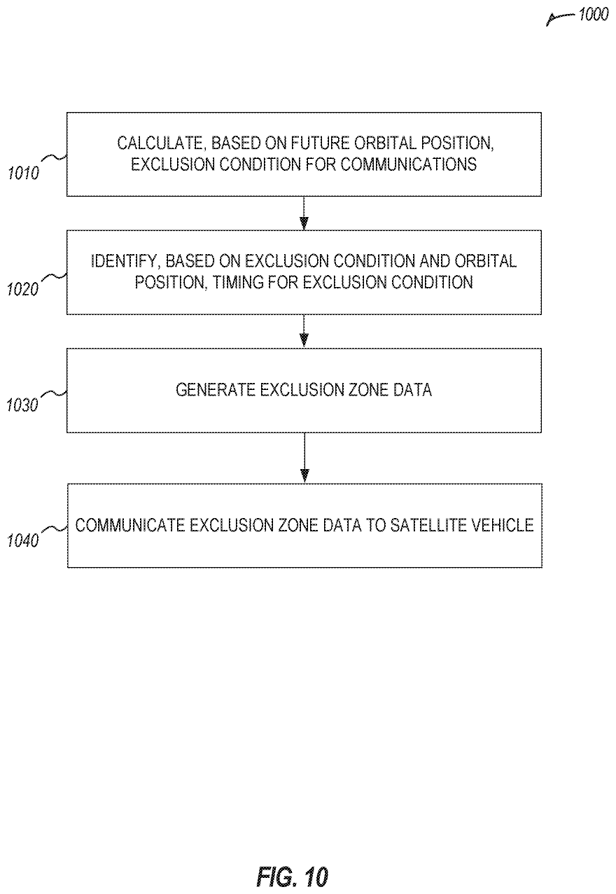

FIG. 10 illustrates a flowchart of an example method 1000 of defining and communicating exclusion zones.

The method begins, at operation 1010, to calculate, based on a future orbital position of a low-Earth orbit satellite vehicle, an exclusion condition for communications from the satellite vehicle.

The method continues, at operation 1020, to identify, based on the exclusion condition and the future orbital position, a timing for implementing the exclusion condition for the communications from the satellite vehicle.

The method continues, at operation 1030, to generate exclusion zone data for use by the satellite vehicle. In an example, the exclusion zone data indicates the timing for implementing the exclusion condition for the communications from the satellite vehicle.

The method completes, at operation 1040, to cause communication of the exclusion zone data to the satellite vehicle. In an example, the operations of the method 1000 are performed by a ground-based data processing server at a regular interval, and this communication occurs from the ground-based data processing server to the satellite vehicle. In further examples, the operations of the method 1000 are performed at least in part using computing hardware of the satellite vehicle.

In an example, the exclusion condition of method 1000 is an exclusion of use of a communication frequency onto a terrestrial geographic area. For instance, the exclusion zone data may further identify the communication frequency, and implementation of the exclusion zone data at the satellite vehicle causes the satellite vehicle to discontinue use of the communication frequency while in communication range over the terrestrial geographic area.

In an example, the exclusion condition of method 1000 is an exclusion of use of a spot beam onto a terrestrial geographic area, and the exclusion zone data further identifies the spot beam of the satellite vehicle, as implementation of the exclusion zone data at the satellite vehicle causes the satellite vehicle to discontinue use of the spot beam while in communication range over the terrestrial geographic area.

In an example, the exclusion condition of method 1000 is an exclusion of use of a cellular network coverage at a geographic area, and implementation of the exclusion zone data at the satellite vehicle causes the satellite vehicle to communicate a command to connected user equipment to discontinue use of a satellite network connection while the satellite vehicle is in communication range of the cellular network coverage at the geographic area.

In an example, the exclusion zone data of method 1000 is communicated to the satellite vehicle with a routing table, as the routing table operates to control the future orbital position of the satellite vehicle. In other examples, aspects of a routing protocol, routing protocol data, routing data, or configuration data (e.g., in a particular format) for routing and routing settings may be communicated. In a further example, the exclusion zone data includes attestation or authentication information for verification by the satellite vehicle. Additionally, in a further example, the exclusion zone data may be designated and used by a plurality of satellite vehicles in a constellation including the satellite vehicle.

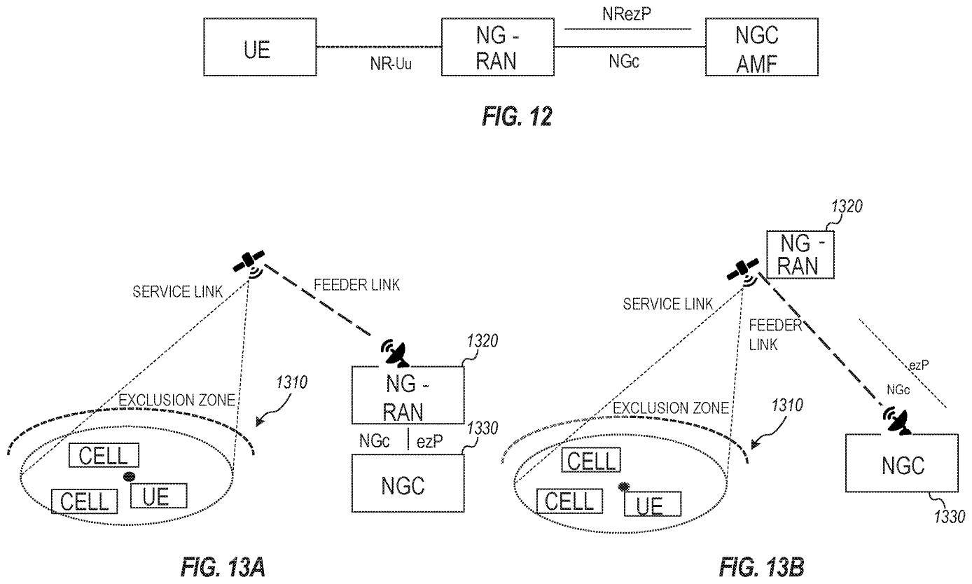

An Exclusion Zone Protocol, as discussed above, can be defined and implemented in connection with these and other exclusion zone implementations. The ezP carries information between the NG-RAN and the AMF (or equivalent), as depicted with the architecture of FIG. 12.

In an example, the ezP is used to support the following EZ functions: 1) Transfer EZ (ezDescription) request from the AMF (or equivalent) to the NG-RAN; 2) Transfer the EZ response from the NG-RAN to the AMF; 3) Exchange information between the NG-RAN and the AMF for the purpose of scheduling an EZ. Other information exchanges may be performed between the AMF and the Satellite Operator. As also noted above, the ezP may use a variety of exclusion zone Information Elements to define data exchanges and information elements.

The ezP may be invoked as the AMF (or equivalent) receives a request to accommodate an ezActivationRequest with a particular ezD. For example, consider a workflow of SAT OPERATOR>EZ ACTIVATION REQUEST>AMF; EZ ACTIVATION REQUEST (ezP IEs: ezD).

The AMF (or equivalent) determines the relevant targeted NG-RAN Node(s) then sends the ezActivationRequest to the relevant targeted ezRanNode(s). An example workflow is: AMF>EZ ACTIVATION REQUEST>NG-RAN(s) EZ ACTIVATION REQUEST (ezP IEs: ezRanNode, ezD).

The NG-RAN processes the ezActivationRequest which may include obtaining and/or transferring assistance data, including satellite orbital telemetry to determine which individual satellite(s) ezSATID, ezSATName, with location and status ezSATLocation, ezSATStatus will intercept the EZ request during the ezActivationTime.

The ezMethod is also included to specify the approach used to accommodate the EZ. An example workflow is: NG-RAN>EZ INFORMATION REQUEST>SAT OPERATOR; EZ INFORMATION REQUEST (ezP IEs: ezSATID, ezSATName, ezSATLocation, ezSATStatus, ezMethod).

The NG-RAN determines what individual satellite(s) will intercept ezInterceptSATID(s) the ezActivationRequest and prepares associated scheduling window ezSchedulingWindow to support satellite instructions to accommodate the EZ request. Then the NG-RAN returns the results of the EZ request including the EZ Scheduling window(s) to the AMF for processing. An example workflow is: NG-RAN>EZ INFORMATION RESPONSE>AMF; EZ INFORMATION RESPONSE (ezP IEs: ezInterceptSATID, ezSchedulingWindow).

The AMF provides the EZ Request instructions to the satellite operator including the EZ window used by the satellite operator to enable/disable radio frequency and/or light pollution to satisfy the EZ request.

The satellite operator schedules the appropriate commands within the EZ scheduling window and then informs the AMF of the ezActivationResponse ezSuccess/ezFailure. An example workflow is: SAT OPERATOR<AMF<EZ ACTIVATION RESPONSE; EZ ACTIVATION RESPONSE (IEs: ezP: ezActivationResponse ezSuccess/ezFailure)

An Exclusion Zone Definition (ezD) information element can be defined as a circular or rectangular area. An example of a circular exclusion or Quiet Zone as per FCC § 1.924 could be specified as, for example: 160 km of 64°17′00.0″N 149°10′00.0″W. A circular ezD can be defined with directly referenced geographical coordinates. An example of a rectangular exclusion or Quiet Zone as per FCC § 1.924 could be specified as: Rectangle 38°40′00″ N. Lat. on the north; 78°50′00″ W. Long. on the east; 38°10′00″ N. Lat. on the south; 79°20′00″ W. Long. on the west.

The ezP protocol terminates between the AMF and the NG-RAN and is used as transport for EZ requests and EZ responses messages over the NG-C interface. The NGAP protocol can also be used to instigate and terminate NG-RAN Node related procedures.

As will be understood, standard EZ Descriptions (and Language) can be shared across Terrestrial/Non-Terrestrial Service Providers for consistency and coordination among multiple 5G Terrestrial and geostationary/non-geostationary orbit (NGO) solutions. Implementations of EZs within separate Constellation Providers may vary but EZ Descriptions for ground-based keep-out areas may be sharable across Service Providers, including Cloud and Telecommunication Service Providers. In general, standard “fixed” EZs descriptions can be used to formulate and influence routing and switching payloads to help Service Providers coordinate as the number of NGO satellites and systems increases.

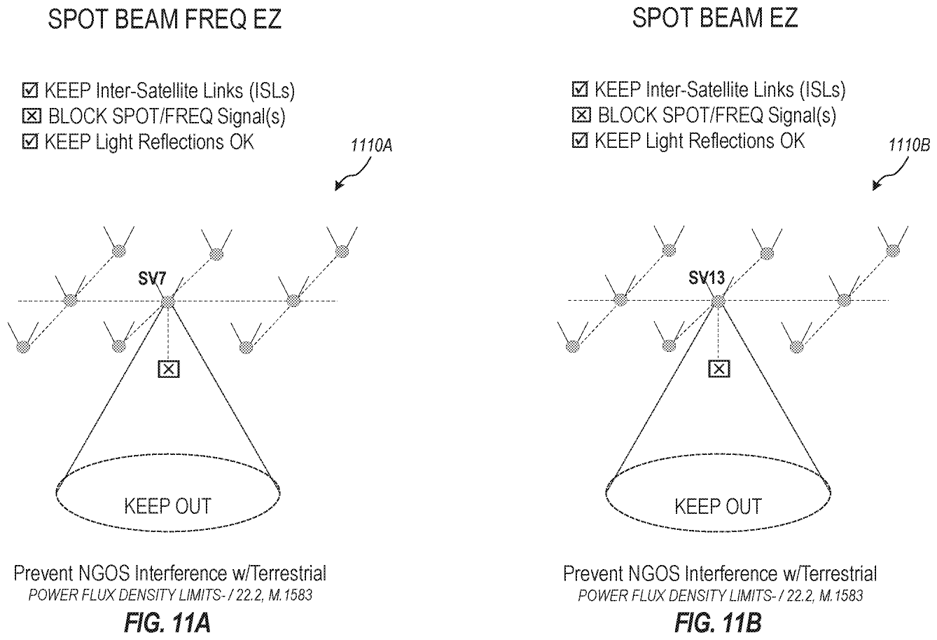

FIG. 11A illustrates further views of an example interference scenario 1110A over a geographic area, and the use of spot beam frequency exclusion zones to implement a keep-out area from SV7. Here, the intent of the EZ is to block specific signals from radiating on the ground, such as where different countries or geographical areas impose different intensity limits. FIG. 11B illustrates further views of an example interference scenario 1110B over a geographic area, and the use of combined spot beam frequency exclusion zones to implement a keep-out area of all frequencies from a spot beam of SV13.

It will be understood that other variations to these approaches may be implemented with EZs to block transmissions onto defined areas. For instance, such exclusion zones may provide permutations of a spot beam block, a frequency block within a beam, or an “ignore” setting when the intensity of the spot beam is below the intensity of allowance in the keep out zone.

Similar to the examples above, specific commands and values that define variations of an exclusion zone may be provided in the form of a supplemental space coverage (SCS) coordination zone or inclusion zone. An inclusion zone may be a definition of a specific area that a network (or network frequency) can operate. A coordination zone may be a definition of a specific area that a network (or network frequency) is to coordinate co-existence. FIGS. 13A and 13B illustrate further views of exclusion zones implemented for transmissions from a non-terrestrial communication network. FIG. 12 illustrates an example configuration of a network architecture between a User Equipment (UE), NG-RAN, and communications between the NG-RAN and the NGC (Next Generation Core), such as to communicate aspects of an exclusion zone for the NR network (via NRezP). In these examples, an AMF may have a proprietary signaling connection between an NGC (Next Generation Core) and the satellite operator. Details of the signaling interaction between the AMF and the satellite operator may vary.

In FIG. 13A, an EZ 1310 is defined to prevent interference from a service link provided from the LEO satellite to a geographic area on earth. This information is provided from use of an exclusion zone protocol (ezP) from an NGC 1330 and an NG-RAN 1320. In FIG. 13B, a similar EZ is defined, but is provided from the NGC 1330 on-Earth to an NG-RAN 1320 operating in the NTN.

In further examples, the EZ can be defined not only to prevent interference from the LEO satellite to Earth via the service link, but also to modify the operation of the feeder link to prevent interference from the LEO satellite to Earth. Accordingly, aspects of the ezP, the ezD, and exclusion/inclusion/coordination features can be defined for the service link and for the feeder link.

### Implementation in Computing Hardware and Edge Computing Scenarios

It will be understood that the present communication and networking arrangements may be integrated with many aspects of edge computing strategies and deployments. Edge computing, at a general level, refers to the transition of compute and storage resources closer to endpoint devices (e.g., consumer computing devices, user equipment, etc.) in order to improve total cost of ownership, reduce application latency, improve service capabilities, and improve compliance with security or data privacy requirements. Edge computing may, in some scenarios, provide a cloud-like distributed service that offers orchestration and management for applications among many types of storage and compute resources. As a result, some implementations of edge computing have been referred to as the “edge cloud” or the “fog”, as powerful computing resources previously available only in large remote data centers are moved closer to endpoints and made available for use by consumers at the “edge” of the network.

In the context of satellite communication networks, edge computing operations may occur, as discussed above, by: moving workloads onto compute equipment at satellite vehicles; using satellite connections to offer backup or (redundant) links and connections to lower-latency services; coordinating workload processing operations at terrestrial access points or base stations; providing data and content via satellite networks; and the like. Thus, many of the same edge computing scenarios that are described below for mobile networks and mobile client devices are equally applicable when using a non-terrestrial network.

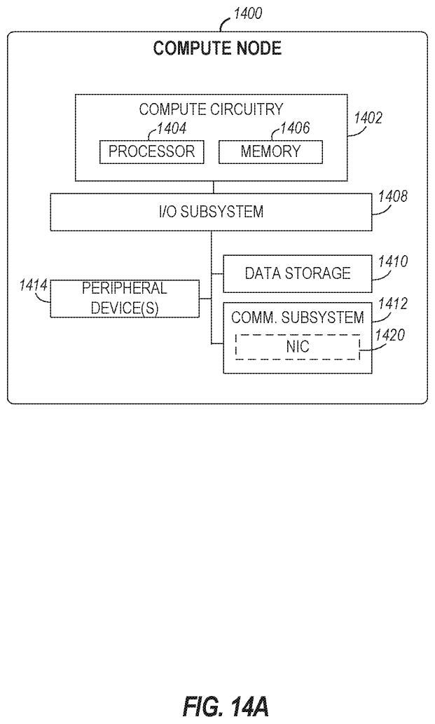

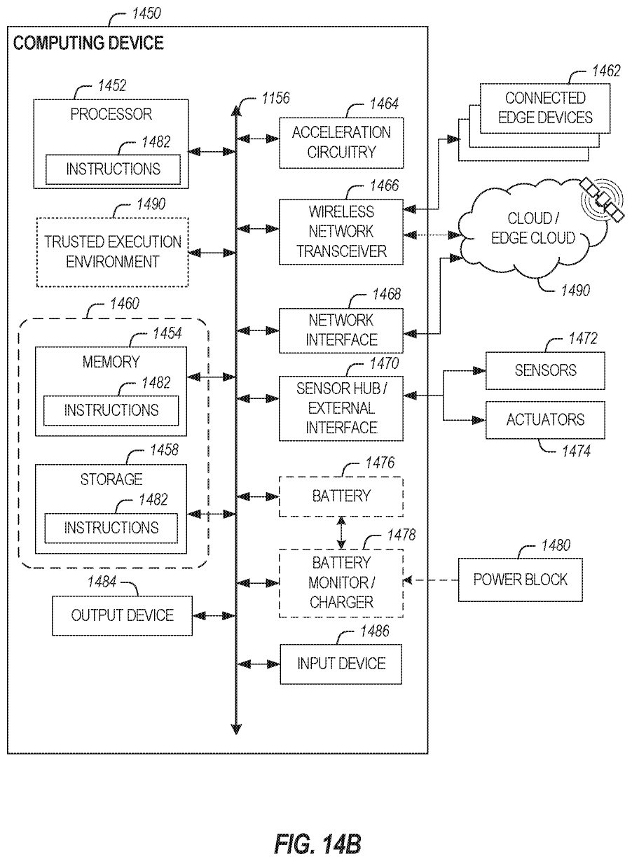

In various examples, any of the compute nodes or devices discussed with reference to the present computing systems and environment may be fulfilled based on the components depicted in FIGS. 14A and 14B. A respective compute node may be embodied as a type of device, appliance, computer, or other “thing” capable of communicating with other edge, networking, or endpoint components.

In the simplified example depicted in FIG. 14A, a compute node 1400 includes a compute engine (also referred to herein as “compute circuitry”) 1402, an input/output (I/O) subsystem 1408, a data storage device 1410, a communication circuitry 1412 subsystem, and, optionally, one or more peripheral devices 1414. In other examples, a compute device may include other or additional components, such as those used in personal or server computing systems (e.g., a display, peripheral devices, etc.). Additionally, in some examples, one or more of the illustrative components may be incorporated in, or otherwise form a portion of, another component.

The compute node 1400 may be embodied as any type of engine, device, or collection of devices capable of performing various compute functions. In some examples, the compute node 1400 may be embodied as a single device such as an integrated circuit, an embedded system, a field-programmable gate array (FPGA), a system-on-a-chip (SOC), or other integrated system or device. In the illustrative example, the compute node 1400 includes or is embodied as a processor 1404 and a memory 1406. The processor 1404 may be embodied as any type of processor capable of performing the functions described herein (e.g., executing an application). For example, the processor 1404 may be embodied as a multi-core processor(s), a microcontroller, or other processor or processing/controlling circuit. In some examples, the processor 1404 may be embodied as, include, or be coupled to an FPGA, an application-specific integrated circuit (ASIC), reconfigurable hardware or hardware circuitry, or other specialized hardware to facilitate performance of the functions described herein.

The main memory 1406 may be embodied as any type of volatile (e.g., dynamic random access memory (DRAM), etc.) or non-volatile memory or data storage capable of performing the functions described herein, with either type of volatile or non-volatile memory constituting a machine-readable storage medium. Volatile memory may be a storage medium that uses power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In one example, the memory device is a block addressable memory device, such as those based on NAND or NOR technologies. A memory device may also include a three-dimensional crosspoint memory device (e.g., Intel 3D XPoint™ memory, other storage class memory), or other byte addressable write-in-place nonvolatile memory devices. The memory device may refer to the die itself and/or to a packaged memory product. In some examples, 3D crosspoint memory (e.g., Intel 3D XPoint™ memory) may comprise a transistor-less stackable cross point architecture in which memory cells sit at the intersection of word lines and bit lines and are individually addressable and in which bit storage is based on a change in bulk resistance. In some examples, all or a portion of the main memory 1406 may be integrated into the processor 1404. The main memory 1406 may store various software and data used during operation such as one or more applications, data operated on by the application(s), libraries, and drivers.

The compute circuitry 1402 is communicatively coupled to other components of the compute node 1400 via the I/O subsystem 1408, which may be embodied as circuitry and/or components to facilitate input/output operations with the compute circuitry 1402 (e.g., with the processor 1404 and/or the main memory 1406) and other components of the compute circuitry 1402. For example, the I/O subsystem 1408 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 1408 may form a portion of a system-on-a-chip (SoC) and be incorporated, along with one or more of the processor 1404, the main memory 1406, and other components of the compute circuitry 1402, into the compute circuitry 1402.

The one or more illustrative data storage devices 1410 may be embodied as any type of devices configured for short-term or long-term storage of data such as, for example, memory devices and circuits, memory cards, hard disk drives, solid-state drives, or other data storage devices. A data storage device 1410 may include a system partition that stores data and firmware code for the data storage device 1410. A data storage device 1410 may also include one or more operating system partitions that store data files and executables for operating systems, depending on, for example, the type of compute node 1400.

The communication circuitry 1412 may be embodied as any communication circuit, device, or collection thereof, capable of enabling communications over a network between the compute circuitry 1402 and another compute device (e.g., an edge gateway node of an edge computing system). The communication circuitry 1412 may be configured to use one or more communication technologies (e.g., wired or wireless communications) and associated protocols (e.g., a cellular networking protocol such as a 3GPP 4G or 5G standard, a wireless local area network protocol such as IEEE 802.11/Wi-Fi®, or a wireless wide area network protocol, Ethernet, Bluetooth®, etc.) to effect such communication.

The communication circuitry 1412 includes a network interface controller (NIC) 1420, which may also be referred to as a host fabric interface (HFI). The NIC 1420 may be embodied as one or more add-in-boards, daughter cards, network interface cards, controller chips, chipsets, or other devices that may be used by the compute node 1400 to connect with another compute device (e.g., an edge gateway node). In some examples, the NIC 1420 may be embodied as part of a system-on-a-chip (SoC) that includes one or more processors, or included on a multichip package that also contains one or more processors. In some examples, the NIC 1420 may include a local processor (not shown) and/or a local memory (not shown) that are both local to the NIC 1420. In such examples, the local processor of the NIC 1420 may be capable of performing one or more of the functions of the compute circuitry 1402 described herein. Additionally or alternatively, in such examples, the local memory of the NIC 1420 may be integrated into one or more components of the client compute node at the board level, socket level, chip level, and/or other levels.

Additionally, in some examples, a compute node 1400 may include one or more peripheral devices 1414. Such peripheral devices 1414 may include any type of peripheral device found in a compute device or server, such as audio input devices, a display, other input/output devices, interface devices, and/or other peripheral devices, depending on the particular type of the compute node 1400. In further examples, the compute node 1400 may be embodied by a respective edge compute node in an edge computing system (e.g., client compute node, edge gateway node, edge aggregation node) or like forms of appliances, computers, subsystems, circuitry, or other components.

In a more detailed example, FIG. 14B illustrates a block diagram of an example of components that may be present in an edge computing node 1450 for implementing the techniques (e.g., operations, processes, methods, and methodologies) described herein. The edge computing node 1450 may include any combination of the components referenced above, and it may include any device usable with an edge communication network or a combination of such networks. The components may be implemented as ICs, portions thereof, discrete electronic devices, or other modules, logic, hardware, software, firmware, or a combination thereof, adapted in the edge computing node 1450, or as components otherwise incorporated within a chassis of a larger system. Further, to support the security examples provided herein, a hardware RoT (e.g., provided according to a DICE architecture) may be implemented in a respective IP Block of the edge computing node 1450 such that any IP Block could boot into a mode where a RoT identity could be generated that may attest its identity and its current booted firmware to another IP Block or to an external entity.

The edge computing node 1450 may include processing circuitry in the form of a processor 1452, which may be a microprocessor, a multi-core processor, a multithreaded processor, an ultra-low voltage processor, an embedded processor, or other known processing elements. The processor 1452 may be a part of a system on a chip (SoC) in which the processor 1452 and other components are formed into a single integrated circuit, or a single package, such as the Edison™ or Galileo™ SoC boards from Intel Corporation, Santa Clara, California. As an example, the processor 1452 may include an Intel® Architecture Core™-based processor, such as a Quark™, an Atom™, a Xeon™ an i3, an i5, an i7, an i9, or an MCU-class processor, or another such processor available from Intel®. However, any number of other processors may be used, such as available from Advanced Micro Devices, Inc. (AMD) of Sunnyvale, California, a MIPS-based design from MIPS Technologies, Inc. of Sunnyvale, California, an ARM-based design licensed from ARM Holdings, Ltd. or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc.

The processor 1452 may communicate with a system memory 1454 over an interconnect 1456 (e.g., a bus). Any number of memory devices may be used to provide for a given amount of system memory. As examples, the memory may be random access memory (RAM) in accordance with a Joint Electron Devices Engineering Council (JEDEC) design, such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP), or quad die package (QDP). These devices, in some examples, may be directly soldered onto a motherboard to provide a lower profile solution, while in other examples, the devices are configured as one or more memory modules that, in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 1458 may also couple to the processor 1452 via the interconnect 1456. In an example, the storage 1458 may be implemented via a solid-state disk drive (SSD). Other devices that may be used for the storage 1458 include flash memory cards, such as SD cards, microSD cards, XD picture cards, and the like, and USB flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magneto-resistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory-based device, a magnetic tunneling junction (MTJ) based device, a DW (Domain Wall) and SOT (Spin Orbit Transfer) based device, a thyristor-based memory device, or a combination of any of the above, or other memory.

In low power implementations, the storage 1458 may be on-die memory or registers associated with the processor 1452. However, in some examples, the storage 1458 may be implemented using a micro hard disk drive (HDD). Further, any number of new technologies may be used for the storage 1458 in addition to, or instead of, the technologies described, such as resistance change memories, phase change memories, holographic memories, or chemical memories, among others.

The components may communicate over the interconnect 1456. The interconnect 1456 may include any number of technologies, including industry standard architecture (ISA), extended ISA (EISA), peripheral component interconnect (PCI), peripheral component interconnect extended (PCIx), PCI express (PCIe), NVLink, or any number of other technologies. The interconnect 1456 may be a proprietary bus, for example, used in an SoC-based system. Other bus systems may be included, such as an I2C interface, an SPI interface, point-to-point interfaces, and a power bus, among others.

The interconnect 1456 may couple the processor 1452 to a transceiver 1466, for communications with the connected edge devices 1462. The transceiver 1466 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 1462. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 1466 (or multiple transceivers) may communicate using multiple standards or radios for communications at a different range. For example, the edge computing node 1450 may communicate with close devices, e.g., within about 10 meters, using a local transceiver based on BLE, or another low-power radio, to save power. More distant connected edge devices 1462, e.g., within about 50 meters, may be reached over ZigBee or other intermediate-power radios. Both communications techniques may take place over a single radio at different power levels or may take place over separate transceivers, for example, a local transceiver using BLE and a separate mesh transceiver using ZigBee.

A wireless network transceiver 1466 (e.g., a radio transceiver) may be included to communicate with devices or services in the edge cloud 1490 via local or wide-area network protocols. The wireless network transceiver 1466 may be an LPWA transceiver that follows the IEEE 802.15.4 or IEEE 802.15.4g standards, among others. The edge computing node 1450 may communicate over a wide area using LoRaWAN™ (Long Range Wide Area Network) developed by Semtech and the LoRa Alliance. The techniques described herein are not limited to these technologies but may be used with any number of other cloud transceivers that implement long-range, low-bandwidth communications, such as Sigfox, and other technologies. Further, other communications techniques, such as time-slotted channel hopping, described in the IEEE 802.15.4e specification, may be used.

Any number of other radio communications and protocols may be used in addition to the systems mentioned for the wireless network transceiver 1466, as described herein. For example, the transceiver 1466 may include a cellular transceiver that uses spread spectrum (SPA/SAS) communications for implementing high-speed communications. Further, any number of other protocols may be used, such as Wi-Fi® networks for medium-speed communications and provision of network communications. The transceiver 1466 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 1468 may be included to provide a wired communication to nodes of the edge cloud 1490 or to other devices, such as the connected edge devices 1462 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 1468 may be included to enable connecting to a second network, for example, a first NIC 1468 providing communications to the cloud over Ethernet, and a second NIC 1468 providing communications to other devices over another type of network.

Given the variety of types of applicable communications from the device to another component or network, applicable communications circuitry used by the device may include or be embodied by any one or more of components in circuitry 1464, transceiver 1466, NIC 1468, or interface 1470. Accordingly, in various examples, applicable means for communicating (e.g., receiving, transmitting, etc.) may be embodied by such communications circuitry.

The edge computing node 1450 may include or be coupled to acceleration circuitry 1464, which may be embodied by one or more AI accelerators, a neural compute stick, neuromorphic hardware, an FPGA, an arrangement of GPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. Accordingly, in various examples, applicable means for acceleration may be embodied by such acceleration circuitry.

The interconnect 1456 may couple the processor 1452 to a sensor hub or external interface 1470 that is used to connect additional devices or subsystems. The devices may include sensors 1472, such as accelerometers, level sensors, flow sensors, optical light sensors, camera sensors, temperature sensors, global positioning system (GPS) sensors, pressure sensors, barometric pressure sensors, and the like. The hub or interface 1470 may also be used to connect the edge computing node 1450 to actuators 1474, such as power switches, valve actuators, an audible sound generator, a visual warning device, and the like.

In some optional examples, various input/output (I/O) devices may be present within or connected to the edge computing node 1450. For example, a display or other output device 1484 may be included to show information, such as sensor readings or actuator position. An input device 1486, such as a touch screen or keypad, may be included to accept input. An output device 1484 may include any number of forms of audio or visual display, including simple visual outputs such as binary status indicators (e.g., LEDs) and multi-character visual outputs, or more complex outputs such as display screens (e.g., LCD screens), with the output of characters, graphics, multimedia objects, and the like being generated or produced from the operation of the edge computing node 1450.

A battery 1476 may power the edge computing node 1450, although, in examples in which the edge computing node 1450 is mounted in a fixed location, it may have a power supply coupled to an electrical grid. The battery 1476 may be a lithium-ion battery, or a metal-air battery, such as a zinc-air battery, an aluminum-air battery, a lithium-air battery, and the like.

A battery monitor/charger 1478 may be included in the edge computing node 1450 to track the state of charge (SoCh) of the battery 1476. The battery monitor/charger 1478 may be used to monitor other parameters of the battery 1476 to provide failure predictions, such as the state of health (SoH) and the state of function (SoF) of the battery 1476. The battery monitor/charger 1478 may include a battery monitoring integrated circuit, such as an LTC4020 or an LTC2990 from Linear Technologies, an ADT7488A from ON Semiconductor of Phoenix, Arizona, or an IC from the UCD90xxx family from Texas Instruments of Dallas, TX. The battery monitor/charger 1478 may communicate the information on the battery 1476 to the processor 1452 over the interconnect 1456. The battery monitor/charger 1478 may also include an analog-to-digital (ADC) converter that enables the processor 1452 to directly monitor the voltage of the battery 1476 or the current flow from the battery 1476. The battery parameters may be used to determine actions that the edge computing node 1450 may perform, such as transmission frequency, mesh network operation, sensing frequency, and the like.

A power block 1480, or other power supply coupled to a grid, may be coupled with the battery monitor/charger 1478 to charge the battery 1476. In some examples, the power block 1480 may be replaced with a wireless power receiver to obtain the power wirelessly, for example, through a loop antenna in the edge computing node 1450. A wireless battery charging circuit, such as an LTC4020 chip from Linear Technologies of Milpitas, California, among others, may be included in the battery monitor/charger 1478. The specific charging circuits may be selected based on the size of the battery 1476, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 1458 may include instructions 1482 in the form of software, firmware, or hardware commands to implement the techniques described herein. Although such instructions 1482 are shown as code blocks included in the memory 1454 and the storage 1458, it may be understood that any of the code blocks may be replaced with hardwired circuits, for example, built into an application-specific integrated circuit (ASIC).

In an example, the instructions 1482 provided via the memory 1454, the storage 1458, or the processor 1452 may be embodied as a non-transitory, machine-readable medium 1460 including code to direct the processor 1452 to perform electronic operations in the edge computing node 1450. The processor 1452 may access the non-transitory, machine-readable medium 1460 over the interconnect 1456. For instance, the non-transitory, machine-readable medium 1460 may be embodied by devices described for the storage 1458 or may include specific storage units such as optical disks, flash drives, or any number of other hardware devices. The non-transitory, machine-readable medium 1460 may include instructions to direct the processor 1452 to perform a specific sequence or flow of actions, for example, as described with respect to the flowchart(s) and block diagram(s) of operations and functionality depicted above. As used herein, the terms “machine-readable medium” and “computer-readable medium” are interchangeable.

In further examples, a machine-readable medium also includes any tangible medium that is capable of storing, encoding, or carrying instructions for execution by a machine and that cause the machine to perform any one or more of the methodologies of the present disclosure or that is capable of storing, encoding, or carrying data structures utilized by or associated with such instructions. A “machine-readable medium” thus may include, but is not limited to, solid-state memories, and optical and magnetic media. Specific examples of machine-readable media include non-volatile memory, including, but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., HTTP).

A machine-readable medium may be provided by a storage device or other apparatus that is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

The block diagrams of FIGS. 14A and 14B are respectively intended to depict a high-level view of components of a device, subsystem, or arrangement of an edge computing node. However, it will be understood that some of the components shown may be omitted, additional components may be present, and a different arrangement of the components shown may occur in other implementations.

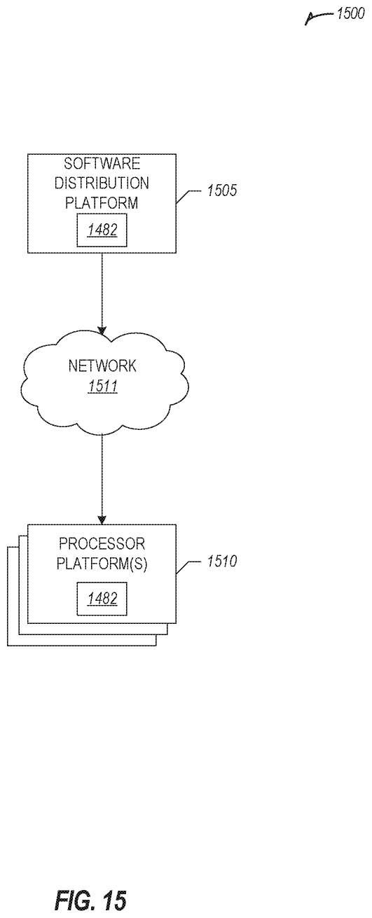

FIG. 15 illustrates an example software distribution platform 1505 to distribute software, such as the example computer-readable instructions 1482 of FIG. 14B, to one or more devices, such as example processor platform(s) 1510 and/or other example connected edge devices or systems discussed herein. The example software distribution platform 1505 may be implemented by any computer server, data facility, cloud service, etc., capable of storing and transmitting software to other computing devices. Example connected edge devices may be customers, clients, managing devices (e.g., servers), third parties (e.g., customers of an entity owning and/or operating the software distribution platform 1505). Example connected edge devices may operate in commercial and/or home automation environments. In some examples, a third party is a developer, a seller, and/or a licensor of software such as the example computer-readable instructions 1482 of FIG. 14B. The third parties may be consumers, users, retailers, OEMs, etc. that purchase and/or license the software for use and/or re-sale and/or sub-licensing. In some examples, distributed software causes display of one or more user interfaces (UIs) and/or graphical user interfaces (GUIs) to identify the one or more devices (e.g., connected edge devices) geographically and/or logically separated from one other (e.g., physically separated IoT devices chartered with the responsibility of water distribution control (e.g., pumps), electricity distribution control (e.g., relays), etc.).

In the illustrated example of FIG. 15, the software distribution platform 1505 includes one or more servers and one or more storage devices that store the computer readable instructions 1482. The one or more servers of the example software distribution platform 1505 are in communication with a network 1515, which may correspond to any one or more of the Internet and/or any of the example networks described above. In some examples, the one or more servers are responsive to requests to transmit the software to a requesting party as part of a commercial transaction. Payment for the delivery, sale and/or license of the software may be handled by the one or more servers of the software distribution platform and/or via a third-party payment entity. The servers enable purchasers and/or licensors to download the computer readable instructions 1482 from the software distribution platform 1505. For example, the software, which may correspond to example computer readable instructions, may be downloaded to the example processor platform(s), which is/are to execute the computer readable instructions 1482. In some examples, one or more servers of the software distribution platform 1505 are communicatively connected to one or more security domains and/or security devices through which requests and transmissions of the example computer readable instructions 1482 must pass. In some examples, one or more servers of the software distribution platform 1505 periodically offer, transmit, and/or force updates to the software (e.g., the example computer readable instructions 1482 of FIG. 14B) to ensure improvements, patches, updates, etc. are distributed and applied to the software at the end user devices.

In the illustrated example of FIG. 15, the computer readable instructions 1482 are stored on storage devices of the software distribution platform 1505 in a particular format. A format of computer readable instructions includes, but is not limited to, a particular code language (e.g., Java, JavaScript, Python, C, C#, SQL, HTML, etc.), and/or a particular code state (e.g., uncompiled code (e.g., ASCII), interpreted code, linked code, executable code (e.g., a binary), etc.). In some examples, the computer readable instructions 1482 stored in the software distribution platform 1505 are in a first format when transmitted to the example processor platform(s) 1510. In some examples, the first format is an executable binary in which particular types of the processor platform(s) 1510 can execute. However, in some examples, the first format is uncompiled code that uses one or more preparation tasks to transform the first format to a second format to enable execution on the example processor platform(s) 1510. For instance, the receiving processor platform(s) 1510 may need to compile the computer readable instructions 1482 in the first format to generate executable code in a second format that is capable of being executed on the processor platform(s) 1510. In still other examples, the first format is interpreted code that, upon reaching the processor platform(s) 1510, is interpreted by an interpreter to facilitate execution of instructions.

### Example Implementation Systems and Methods

Additional examples of the presently described method, system, and device embodiments include the following, non-limiting implementations. Each of the following non-limiting examples may stand on its own or may be combined in any permutation or combination with any one or more of the other examples provided below or throughout the present disclosure.

Example 1 is a method of controlling satellite network operations, comprising: identifying an exclusion condition for transmissions from a satellite network, wherein the exclusion condition is identified from information depicted in at least one image of an on-Earth geographic area; defining a dynamic communication restriction zone to correspond to the on-Earth geographic area, the zone including specifications defined from: identifying at least one mitigation operation for the dynamic communication restriction zone, based on the exclusion condition; and identifying an activation time window for the dynamic communication restriction zone, used to enforce the dynamic communication restriction zone over the on-Earth geographic area; and communicating the specifications of the dynamic communication restriction zone to at least one satellite of the satellite network, to cause the at least one satellite of the satellite network to modify transmission operations while over the on-Earth geographic area.

In Example 2, the subject matter of Example 1 optionally includes wherein identifying the exclusion condition is based on an automated detection of an object or a scenario associated with the object, from the information depicted in the at least one image.

In Example 3, the subject matter of Example 2 optionally includes wherein the at least one image of the on-Earth geographic area is captured by a satellite image source or an aerial image source.

In Example 4, the subject matter of any one or more of Examples 2-3 optionally includes wherein the at least one image of the on-Earth geographic area is captured by a same satellite or a same satellite constellation that provides the transmission operations.

In Example 5, the subject matter of any one or more of Examples 2-4 optionally includes wherein the automated detection of the object or the scenario associated with the object is performed using at least one artificial intelligence (AI) inference model.

In Example 6, the subject matter of any one or more of Examples 1-5 optionally includes wherein defining the dynamic communication restriction zone is based on an automated definition of the dynamic communication restriction zone performed using at least one artificial intelligence (AI) agent that invokes at least one AI inferencing model, wherein the at least one inferencing model is used in an automated process controlled by the at least one AI agent that receives the at least one image of the on-Earth geographic area as input, and provides (i) geographic parameters of the on-Earth geographic area, (ii) the at least one mitigation operation, and (iii) the activation time window as outputs.

In Example 7, the subject matter of any one or more of Examples 1-6 optionally includes wherein the on-Earth geographic area is a fixed geographic area, wherein the dynamic communication restriction zone corresponds to an area shape defined relative to a fixed point within or an offset fixed point located adjacent to the on-Earth geographic area, and wherein the area shape is: a circle; a rectangle; a polygon; or a multi-point shape derived from at least one object depicted in the at least one image of the on-Earth geographic area.

In Example 8, the subject matter of any one or more of Examples 1-7 optionally includes wherein implementation of the dynamic communication restriction zone with the at least one satellite causes a power adaptation to a feeder link between the satellite network and a ground station, the ground station located within the on-Earth geographic area or within a predefined radius of the on-Earth geographic area.

In Example 9, the subject matter of any one or more of Examples 1-8 optionally includes wherein the dynamic communication restriction zone is an exclusion zone, and wherein the exclusion zone is configured to (i) disable transmissions from the satellite network to the on-Earth geographic area, (ii) attenuate a transmission from the satellite network to the on-Earth geographic area; or (iii) steer one or more transmission beams of the satellite network away from the on-Earth geographic area.

In Example 10, the subject matter of any one or more of Examples 1-9 optionally includes wherein the method is performed by a computing device located on-Earth or located in a satellite vehicle, and wherein the communicating of the specifications of the dynamic communication restriction zone is provided from the computing device to the at least one satellite of the satellite network in connection with telemetry tracking and command (TTC) information for the satellite network.

In Example 11, the subject matter of any one or more of Examples 1-10 optionally includes wherein the dynamic communication restriction zone is an inclusion zone, and wherein the inclusion zone is configured to (i) require transmissions from the satellite network to the on-Earth geographic area, (ii) increase transmissions from the satellite network to the on-Earth geographic area; or (iii) direct one or more transmission beams of the satellite network to the on-Earth geographic area.

In Example 12, the subject matter of any one or more of Examples 1-11 optionally includes wherein the at least one mitigation operation is a communication exclusion or coordination restriction to mitigate transmissions from the satellite network to the on-Earth geographic area, based on use of at least one mitigation provided from: spot beam control, frequency change, or beam steering.

In Example 13, the subject matter of any one or more of Examples 1-12 optionally includes wherein the satellite network is a low Earth orbit (LEO) satellite communications network comprising a plurality of satellites in at least one constellation.

In Example 14, the subject matter of any one or more of Examples 1-13 optionally includes wherein the communication exclusion or coordination restrictions control satellite communications to terrestrial terminals established with a direct attachment to a user equipment, in accordance with one or more frequency bands defined by a Fifth Generation (5G) Non-Terrestrial Network (NTN) network specification operating in a frequency division duplex (FDD) mode.

Example 15 is a device, comprising: processing circuitry; and a memory device including instructions embodied thereon, wherein the instructions, which when executed by the processing circuitry, configure the processing circuitry to perform operations for satellite image-enhanced satellite terrestrial communication restriction zones, in accordance with any of Examples 1 to 14 or the other techniques discussed herein.

Example 16 is a method, comprising a plurality of operations executed with a processor and memory of a device, to perform operations for satellite image-enhanced satellite terrestrial communication restriction zones, in accordance with any of Examples 1 to 14 or the other techniques discussed herein.

Example 17 is a non-transitory machine-readable storage medium including instructions, wherein the instructions, when executed by a processing circuitry of a machine, cause the processing circuitry to perform operations for satellite image-enhanced satellite terrestrial communication restriction zones, in accordance with any of Examples 1 to 14 or the other techniques discussed herein.

Example 18 is an apparatus, comprising respective means for deploying or configuring satellite image-enhanced satellite terrestrial communication restriction zones, in accordance with any of Examples 1 to 14 or the other techniques discussed herein.

Example 19 is a satellite vehicle comprising circuitry for deploying or configuring satellite image-enhanced satellite terrestrial communication restriction zones, in accordance with any of Examples 1 to 14 or the other techniques discussed herein.

Example 20 is a network comprising respective devices and device communication mediums for performing any of Examples 1 to 14 or any of the operations or techniques discussed herein.

Example 21 is a system comprising respective components arranged or configured to perform or implement any of Examples 1 to 20 or any of the operations or techniques discussed herein.

Example 22 is a method, performed using circuitry of a computing device, as arranged or configured to perform or implement any of Examples 1 to 20 or any of the operations or techniques discussed herein.

In the examples above, many references were provided to low-Earth orbit (LEO) satellites and constellations. However, it will be understood that the examples above are also relevant to many forms of middle-earth orbit satellites and constellations, geosynchronous orbit satellites and constellations, and other high altitude communication platforms such as balloons. Thus, it will be understood that the techniques discussed for LEO network settings are also applicable to many other network settings.

Although these implementations have been described with reference to specific exemplary aspects, it will be evident that various modifications and changes may be made to these aspects without departing from the broader scope of the present disclosure. Many of the arrangements and processes described herein can be used in combination or in parallel implementations that involve terrestrial network connectivity (where available) to increase network bandwidth/throughput and to support additional edge services. Accordingly, the specification and drawings are to be regarded in an illustrative rather than a restrictive sense. The accompanying drawings that form a part hereof show, by way of illustration, and not of limitation, specific aspects in which the subject matter may be practiced. The aspects illustrated are described in sufficient detail to enable those skilled in the art to practice the teachings disclosed herein. Other aspects may be utilized and derived therefrom, such that structural and logical substitutions and changes may be made without departing from the scope of this disclosure. This Detailed Description, therefore, is not to be taken in a limiting sense, and the scope of various aspects is defined only by the appended claims, along with the full range of equivalents to which such claims are entitled.

Such aspects of the inventive subject matter may be referred to herein, individually, and/or collectively, merely for convenience and without intending to voluntarily limit the scope of this application to any single aspect or inventive concept if more than one is in fact disclosed. Thus, although specific aspects have been illustrated and described herein, it should be appreciated that any arrangement calculated to achieve the same purpose may be substituted for the specific aspects shown. This disclosure is intended to cover any and all adaptations or variations of various aspects. Combinations of the above aspects and other aspects not specifically described herein will be apparent to those of skill in the art upon reviewing the above description.

What is claimed is:

1. A method of controlling satellite network operations, comprising:
identifying an exclusion condition for transmissions from a satellite network, wherein the exclusion condition is identified from information depicted in at least one image of an on-Earth geographic area;
defining a dynamic communication restriction zone to correspond to the on-Earth geographic area, the zone including specifications defined from:
identifying at least one mitigation operation for the dynamic communication restriction zone, based on the exclusion condition; and
identifying an activation time window for the dynamic communication restriction zone, used to enforce the dynamic communication restriction zone over the on-Earth geographic area; and
communicating the specifications of the dynamic communication restriction zone to at least one satellite of the satellite network, to cause the at least one satellite of the satellite network to modify transmission operations while over the on-Earth geographic area.

2. The method of claim 1, wherein identifying the exclusion condition is based on an automated detection of an object or a scenario associated with the object, from the information depicted in the at least one image.

3. The method of claim 2, wherein the at least one image of the on-Earth geographic area is captured by a satellite image source or an aerial image source.

4. The method of claim 2, wherein the at least one image of the on-Earth geographic area is captured by a same satellite or a same satellite constellation that provides the transmission operations.

5. The method of claim 2, wherein the automated detection of the object or the scenario associated with the object is performed using at least one artificial intelligence (AI) inference model.

6. The method of claim 1, wherein defining the dynamic communication restriction zone is based on an automated definition of the dynamic communication restriction zone performed using at least one artificial intelligence (AI) agent that invokes at least one AI inferencing model,
wherein the at least one AI inferencing model is used in an automated process controlled by the at least one AI agent that receives the at least one image of the on-Earth geographic area as input, and provides (i) geographic parameters of the on-Earth geographic area, (ii) the at least one mitigation operation, and (iii) the activation time window as outputs.

7. The method of claim 1, wherein the on-Earth geographic area is a fixed geographic area, wherein the dynamic communication restriction zone corresponds to an area shape defined relative to a fixed point within or an offset fixed point located adjacent to the on-Earth geographic area, and
wherein the area shape is:
a circle;
a rectangle;
a polygon; or
a multi-point shape derived from at least one object depicted in the at least one image of the on-Earth geographic area.

8. The method of claim 1, wherein implementation of the dynamic communication restriction zone with the at least one satellite causes a power adaptation to a feeder link between the satellite network and a ground station, the ground station located within the on-Earth geographic area or within a predefined radius of the on-Earth geographic area.

9. The method of claim 1, wherein the dynamic communication restriction zone is an exclusion zone, and wherein the exclusion zone is configured to (i) disable transmissions from the satellite network to the on-Earth geographic area, (ii) attenuate a transmission from the satellite network to the on-Earth geographic area; or (iii) steer one or more transmission beams of the satellite network away from the on-Earth geographic area.

10. The method of claim 1, wherein the method is performed by a computing device located on-Earth or located in a satellite vehicle, and wherein the communicating of the specifications of the dynamic communication restriction zone is provided from the computing device to the at least one satellite of the satellite network in connection with telemetry tracking and command (TTC) information for the satellite network.

11. A computing device, comprising:
processing circuitry; and
at least one machine-readable medium including instructions embodied thereon, wherein the instructions, when executed by the processing circuitry, configure the processing circuitry to cause operations that:
identify an exclusion condition for transmissions from a satellite network, wherein the exclusion condition is identified from information depicted in at least one image of an on-Earth geographic area;
define a dynamic communication restriction zone to correspond to the on-Earth geographic area, the zone including specifications defined from:
identification of at least one mitigation operation for the dynamic communication restriction zone, based on the exclusion condition; and
identification of an activation time window for the dynamic communication restriction zone, used to enforce the dynamic communication restriction zone over the on-Earth geographic area; and
communicate the specifications of the dynamic communication restriction zone to at least one satellite of the satellite network, to cause the at least one satellite of the satellite network to modify transmission operations while over the on-Earth geographic area.

12. The computing device of claim 11, wherein operations to identify the exclusion condition are based on an automated detection of an object or a scenario associated with the object, from the information depicted in the at least one image.

13. The computing device of claim 12, wherein the at least one image of the on-Earth geographic area is captured by a satellite image source or an aerial image source.

14. The computing device of claim 12, wherein the at least one image of the on-Earth geographic area is captured by a same satellite or a same satellite constellation that provides the transmission operations.

15. The computing device of claim 12, wherein the automated detection of the object or the scenario associated with the object is performed using at least one artificial intelligence (AI) inference model.

16. The computing device of claim 11, wherein operations to define the dynamic communication restriction zone are based on an automated definition of the dynamic communication restriction zone performed using at least one artificial intelligence (AI) agent that invokes at least one AI inferencing model,
wherein the at least one AI inferencing model is used in an automated process controlled by the at least one AI agent that receives the at least one image of the on-Earth geographic area as input, and provides (i) geographic parameters of the on-Earth geographic area, (ii) the at least one mitigation operation, and (iii) the activation time window as outputs.

17. The computing device of claim 11, wherein the on-Earth geographic area is a fixed geographic area, wherein the dynamic communication restriction zone corresponds to an area shape defined relative to a fixed point within or an offset fixed point located adjacent to the on-Earth geographic area, and
wherein the area shape is:
a circle;
a rectangle;
a polygon; or
a multi-point shape derived from at least one object depicted in the at least one image of the on-Earth geographic area.

18. The computing device of claim 11, wherein implementation of the dynamic communication restriction zone with the at least one satellite causes a power adaptation to a feeder link between the satellite network and a ground station, the ground station located within the on-Earth geographic area or within a predefined radius of the on-Earth geographic area.

19. The computing device of claim 11, wherein the dynamic communication restriction zone is an exclusion zone, and wherein the exclusion zone is configured to (i) disable transmissions from the satellite network to the on-Earth geographic area, (ii) attenuate a transmission from the satellite network to the on-Earth geographic area; or (iii) steer one or more transmission beams of the satellite network away from the on-Earth geographic area.

20. The computing device of claim 11, wherein the computing device is located on-Earth or located in a satellite vehicle, and wherein communication of the specifications of the dynamic communication restriction zone is provided from the computing device to the at least one satellite of the satellite network in connection with telemetry tracking and command (TTC) information for the satellite network.
